(19) United States
(12) Patent Application Publication
(10) Pub. No.: US 2025/0332513 A1
(43) Pub. Date: Oct. 30, 2025

(54) VIRTUAL CHARACTER GENERATION AND ASSOCIATION IN GAMES

(71) Applicant: Tencent Technology (Shenzhen) Company Limited, Shenzhen (CN)

(72) Inventor: Liang ZHANG, Shenzhen (CN)

(73) Assignee: Tencent Technology (Shenzhen) Company Limited, Shenzhen (CN)

(21) Appl. No.: 19/262,055

(22) Filed: Jul. 7, 2025

Related U.S. Application Data
(63) Continuation of application No. PCT/CN2024/085607, filed on Apr. 2, 2024.

(30) Foreign Application Priority Data
May 6, 2023 (CN) 202310508543.3

(51) Int. Cl. A63F 13/67; A63F 13/52

(52) U.S. Cl. CPC A63F 13/67; A63F 13/52

(57) ABSTRACT

In a game processing method in a game application, a virtual object request is received. A first virtual object in response to the virtual object request is obtained. The first virtual object is generated based on a first keyword that is selected from a keyword set and is associated with the first virtual object. The first virtual object is displayed. In response to an object association request, an indication that the first virtual object is associated with a second virtual object when the second virtual object controlled by a user is associated with the first virtual object is displayed. Apparatus and non-transitory computer-readable storage medium counterpart embodiments are also contemplated.

### RELATED APPLICATIONS

The present application is a continuation of International Application No. PCT/CN2024/085607, filed on Apr. 2, 2024, which claims priority to Chinese Patent Application No. 202310508543.3, filed on May 6, 2023. The entire disclosures of the prior applications are hereby incorporated by reference.

### FIELD OF THE TECHNOLOGY

This application relates to the field of computer technologies, including a game processing method.

### BACKGROUND OF THE DISCLOSURE

With the development of the Internet and the enrichment of entertainment life, more game applications are emerging. A non-player character (NPC) is usually indispensable in a game application. During development of a game application, a developer sets up various NPCs in the game application to interact with players. For example, for a role-playing game (RPG) or a collectible card game, an NPC in each of these game applications needs to be generated in the development phase of the game application, and a tangible card collection album or NPC introduction needs to be provided to a player, whereby the player can understand the gameplay of the game application. However, once every NPC is revealed to the player in advance, the game can no longer introduce new or unexpected characters during play, which greatly reduces the flexibility of the game.

### SUMMARY

Aspects of this disclosure include a game processing method, an apparatus, and a non-transitory computer-readable storage medium, to improve intelligence and flexibility of a game.

Examples of technical solutions of this disclosure may be implemented as follows:

An aspect of this disclosure provides a game processing method in a game application. A virtual object request is received. A first virtual object in response to the virtual object request is obtained. The first virtual object is generated based on a first keyword that is selected from a keyword set and is associated with the first virtual object. The first virtual object is displayed. In response to an object association request, an indication that the first virtual object is associated with a second virtual object when the second virtual object controlled by a user is associated with the first virtual object is displayed.

An aspect of this disclosure provides a game processing apparatus, including processing circuitry configured to receive a virtual object request. The processing circuitry is configured to obtain a first virtual object in response to the virtual object request. The first virtual object is generated based on a first keyword that is selected from a keyword set and is associated with the first virtual object. The processing circuitry is configured to display the first virtual object. The processing circuitry is configured to display, in response to an object association request, an indication that the first virtual object is associated with a second virtual object when the second virtual object controlled by a user is associated with the first virtual object.

Aspects of this disclosure provide a game processing method, which includes: displaying a first virtual object in response to an object search operation, the first virtual object being an intelligently running game object and generated according to a first object keyword; and the first object keyword being acquired from a keyword set based on the object search operation; and displaying an association success result for the first virtual object in response to an object association request of a second virtual object for the first virtual object when the first virtual object is successfully associated with the second virtual object, the second virtual object being a game object controlled by a game operator.

Aspects of this disclosure provide a game processing apparatus, which includes: an object display module, configured to display a first virtual object in response to an object search operation, the first virtual object being an intelligently running game object and generated according to a first object keyword; and the first object keyword being acquired from a keyword set based on the object search operation; and an object association module, configured to display an association success result for the first virtual object in response to an object association request of a second virtual object for the first virtual object when the first virtual object is successfully associated with the second virtual object, the second virtual object being a game object controlled by a game operator.

The object display module includes: an object waiting unit, configured to display an object search waiting page in response to the object search operation; and an object display unit, configured to display the first virtual object when the first virtual object is generated based on the object search operation, the object search waiting page being configured to wait for generation of the first virtual object.

The apparatus further includes: a component display module, configured to display a first game interface in response to a page closing operation for the object search waiting page, and display a first association component on the first game interface, the first game interface being an interface for interaction in a game application; and the first association component being a component configured to return a related page of an object association function.

The object display unit includes: a completion prompt subunit, configured to display search completion data for the first association component when the first virtual object is generated based on the object search operation; and an object display subunit, configured to display the first virtual object in response to a trigger operation for the first association component.

The apparatus further includes: a page closing module, configured to display the first game interface in response to the page closing operation for the object search waiting page; a wait display module, configured to display the object search waiting page in response to a trigger operation for a second association component displayed on the first game interface if the first virtual object is not generated, the second association component being a component that is integrated in a functional area of the game application and that is configured to trigger searching for a virtual object; and an object triggering module, configured to perform a process of displaying the first virtual object in response to the trigger operation for the second association component displayed on the first game interface if the first virtual object is generated based on the object search operation.

The apparatus further includes: an information display module, configured to display a first object avatar and first object information for the first virtual object, the first object avatar and the first object information being generated based on the acquired first object keyword; and the first object information being configured to describe the first virtual object and including a first object speech; and a speech playback module, configured to play the first object speech in response to a trigger operation for the first object speech.

The apparatus further includes: an object deletion module, configured to display a third association component, and delete an unassociated object from the first virtual object in response to a trigger operation for the third association component, the unassociated object being a first virtual object that is not associated with the second virtual object; the second virtual object being a virtual object triggering the object search operation; and the third association component being configured to re-trigger a process of generating the first virtual object; and the wait display module, further configured to display the object search waiting page, the object search waiting page being configured to wait for re-generation of the first virtual object.

A quantity of first virtual objects is N, and Nis a positive integer; and the object association module includes: an association waiting unit, configured to display an association waiting message in response to an object association request for a target virtual object in the N first virtual objects; and an association success unit, configured to display a success prompt message for the target virtual object if the second virtual object is successfully associated with the target virtual object, and display a success confirmation component.

The object association module further includes: an association failure unit, configured to display a failure prompt message for the target virtual object if the second virtual object fails to be associated with the target virtual object, and display a failure confirmation component.

The apparatus further includes: a failure triggering module, configured to return to display the N first virtual objects in response to a trigger operation for the failure confirmation component; and a failure prompt module, configured to associatively display an association failure message for the target virtual object, the association failure message being configured to indicate that the object association request is not triggered for the target virtual object.

If the second virtual object is successfully associated with the target virtual object, the apparatus further includes: an association notification module, configured to output an object association message between the first virtual object and the second virtual object in a system notification area; and a success triggering module, configured to display a second game interface in response to a trigger operation for the success confirmation component if a first associated object in the N first virtual objects is greater than or equal to a unit association threshold, the first associated object being a first virtual object that is in the N first virtual objects and that is associated with the second virtual object, the success triggering module being further configured to return to display the N first virtual objects if the first associated object in the N first virtual objects is less than the unit association threshold.

If the second virtual object is successfully associated with the target virtual object, the apparatus further includes: a list display module, configured to display a game object list in response to a viewing operation for the game object list of the second virtual object, the game object list including a second associated object of the second virtual object; and the second associated object being a virtual object associated with the second virtual object, being an intelligently running game object, and including the target virtual object; and a session display module, configured to display a session page with the target virtual object in response to a session request for the target virtual object; a bias display module, configured to display an object topic bias option of the target virtual object on the session page with the target virtual object, the object topic bias option including M object topic biases, and M being a positive integer; and the M object topic biases being configured to represent different ideas for one object topic, and the object topic being a topic type of session communication; and a bias selection module, configured to associate a first object topic bias with the target virtual object in response to a selection operation for the first object topic bias of the M object topic biases.

The object display module includes: a first generation unit, configured to randomly determine a first object attribute in response to the object search operation, and generate a first object name based on the first object attribute, the first object attribute being configured to represent a basic feature of one virtual object; a set acquisition unit, configured to acquire a first keyword set associated with the first object attribute from the keyword set, the first keyword set including K keywords, as well as object categories and phrase weights that respectively correspond to the K keywords; a phrase selection unit, configured to randomly select the first object keyword from keywords in a same object category based on the phrase weights respectively corresponding to the K keywords; a second generation unit, configured to render the first object keyword into the first virtual object; and the object display unit, further configured to display the first virtual object.

The second generation unit includes: an avatar generation subunit, configured to render an avatar-associated phrase in the first object keyword into the first object avatar; a data generation subunit, configured to acquire a game world background of the game application, and perform data description integration on the first object keyword and the game world background, to generate first object description data and object initial data, the first object description data being configured to represent an introduction to the first virtual object, and the object initial data being configured to represent session data between the first virtual object and the second virtual object; and the second virtual object being a virtual object triggering the object search operation; a speech generation subunit, configured to acquire a timbre option corresponding to the first object attribute, randomly select a first object timbre from the timbre option, and perform speech conversion on the object initial data based on the first object timbre, to generate the first object speech; and an object generation subunit, configured to generate the first virtual object according to the first object avatar, the first object description data, and the first object speech.

The apparatus further includes: a relationship acquisition module, configured to acquire a game relationship in the game application, acquire the first object attribute and a second object attribute of the second virtual object, and acquire a first game relationship of association between the first object attribute and the second object attribute from the game relationship, the first game relationship being configured to represent an establishable relationship between the first virtual object and the second virtual object; and the second virtual object being a virtual object triggering the object search operation; a relationship prompt module, configured to display a relationship establishment prompt message when the first virtual object and the second virtual object satisfy an establishment condition of a second game relationship, the first game relationship including the second game relationship; and a relationship establishment module, configured to establish the second game relationship between the first virtual object and the second virtual object in response to a relationship establishment operation for the relationship establishment prompt message.

The apparatus further includes: a phrase acquisition module, configured to acquire an object missing scene in the game application if a virtual object of a first object type is missing from the game application, and acquire an application object keyword based on the first object type and the object missing scene; and an object output module, configured to render the application object keyword into a third virtual object, and output the third virtual object in the object missing scene, the third virtual object being an intelligently running game object.

Aspects of this disclosure provide a computer device, which includes a processor, a memory, and an input/output interface.

The processor is connected to the memory and the input/output interface, respectively, the input/output interface is configured to receive and output data, the memory is configured to store a computer program, and the processor is configured to invoke the computer program, to cause the computer device including the processor to perform the game processing method according to the aspects of this disclosure.

Aspects of this disclosure provide a non-transitory computer-readable storage medium, having computer-executable instructions stored therein, the computer-executable instructions, when executed by a processor, cause the processor to implement the game processing method according to the aspects of this disclosure.

Aspects of this disclosure provide a computer program product or a computer program, which includes computer instructions. The computer instructions are stored in a computer-readable storage medium. A processor of a computer device reads the computer instructions from the computer-readable storage medium and executes the computer instructions, to cause the computer device to perform the method provided in each alternative implementation in the aspects of this disclosure. In other words, the processor executes the computer instructions to implement the method provided in each alternative implementation in the aspects of this disclosure.

Aspects of this disclosure have the following beneficial effects:

In the aspects of this disclosure, the first virtual object may be displayed in response to the object search operation. The first virtual object is an intelligently running game object and is generated according to the first object keyword. The first object keyword is acquired from the keyword set based on the object search operation. The association success result for the first virtual object is displayed in response to the object association request of the second virtual object for the first virtual object when the second virtual object is successfully associated with the first virtual object. The second virtual object is a game object controlled by the game operator. Through the foregoing process, the first virtual object may be generated. The generation is performed based on the acquired first object keyword, whereby each first virtual object is generated in real time when requested. Before the first virtual object is displayed, a player does not know which virtual object will be displayed, or even does not know where the virtual object will be displayed. In this way, the first virtual object is unknown to the player. In addition, the virtual object does not need to be generated in advance. In this way, various and infinite virtual objects can be generated in a published game application by the method, to improve intelligence and flexibility of a game. In addition, generation of the virtual object is not limited (that is, no limit is set), whereby various virtual objects can be randomly generated from different directions, different keywords, and the like. In this way, extensibility of the game is improved. Therefore, the game application is not limited to existing game resources, richness of the game is improved, and the playability of the game can be improved to an extent.

### BRIEF DESCRIPTION OF THE DRAWINGS

FIG. 1 is a diagram of a network interaction architecture of game processing according to an aspect of this disclosure.

FIG. 2 is a diagram of a game processing scene according to an aspect of this disclosure.

FIG. 3 is a flowchart of a game processing method according to an aspect of this disclosure.

FIG. 4 is a schematic diagram of object generation according to an aspect of this disclosure.

FIG. 5 is a schematic diagram of game scene switching according to an aspect of this disclosure.

FIG. 6 is a schematic diagram of an object search scene according to an aspect of this disclosure.

FIG. 7 is a schematic diagram of an object association scene according to an aspect of this disclosure.

FIG. 8 is a schematic diagram of an object re-search scene according to an aspect of this disclosure.

FIG. 9 is a schematic diagram of an association scene according to an aspect of this disclosure.

FIG. 10 is a schematic diagram of another association scene according to an aspect of this disclosure.

FIG. 11 is a flowchart of a specific implementation of a game processing method according to an aspect of this disclosure.

FIG. 12 is a schematic diagram of a virtual object generation scene according to an aspect of this disclosure.

FIG. 13 is a schematic diagram of a timbre selection scene according to an aspect of this disclosure.

FIG. 14 is a schematic diagram of a game processing apparatus according to an aspect of this disclosure.

FIG. 15 is a schematic structural diagram of a computer device according to an aspect of this disclosure.

### DETAILED DESCRIPTION

Technical solutions in the aspects of this disclosure are described in the following with reference to the accompanying drawings in the aspects of this disclosure. The described aspects are merely some rather than all of the aspects of this disclosure. All other aspects obtained by those of ordinary skill in the art based on the aspects in this disclosure fall within the scope of this disclosure. Further, the descriptions of the terms are provided as examples only and are not intended to limit the scope of the disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In an aspect of this disclosure, a first virtual object is generated and displayed by an artificial intelligence (AI) technology.

AI is a theory, a method, a technology, and an application system in which human intelligence is simulated and extended by using a digital computer or a machine controlled by a digital computer to perceive an environment, acquire knowledge, and obtain an optimal result by using the knowledge. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies include technologies such as a sensor, a dedicated AI chip, cloud computing, distributed storage, a big data processing technology, an operating/interaction system, and electromechanical integration. The AI software technologies mainly include some major directions such as a computer vision technology, a speech processing technology, a natural language processing technology, and machine learning/deep learning, autonomous driving, and intelligent transportation.

With the research and progress of the AI technology, the AI technology is researched and applied to a plurality of fields such as common smart homes, smart wearable devices, virtual assistants, smart speakers, smart marketing, unmanned driving, autonomous driving, unmanned aerial vehicles, robots, smart healthcare, smart customer services, the Internet of Vehicles, autonomous driving, and intelligent transportation. It is believed that with the development of the technology, the AI technology will be applied to more fields and exert increasingly important values, for example, applied to the field of game intelligence to which this disclosure belongs.

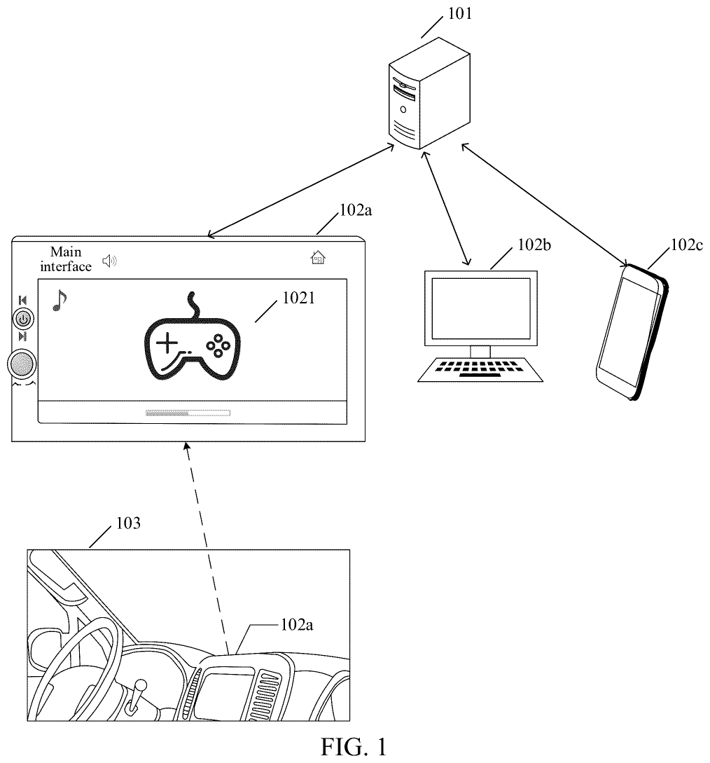

In the aspects of this disclosure, FIG. 1 is a diagram of a network interaction architecture of game processing according to an aspect of this disclosure. As shown in FIG. 1, one or more service devices may exist. In an aspect, one or more servers exist. “More” herein means at least two. The service device is a device capable of running a game application, such as a service device 102a, a service device 102b, or a service device 102c shown in FIG. 1. The server may be a device capable of managing the game application, such as a server 101 shown in FIG. 1. The aspects of this disclosure may be implemented by a computer device, which may be any service device. Data interaction may be directly performed between the service devices, or data interaction may be performed through the server 101. This is not limited herein. The computer device may generate a first virtual object in response to an object search operation, and display the first virtual object, and a game user may request to perform association with the first virtual object, to implement flexible and random generation of the first virtual object. Therefore, before viewing the generated first virtual object, the game user cannot predict the first virtual object. In this way, the game user has more expectations and surprises about the generation of the first virtual object. Therefore, playability and richness of a game are improved. In addition, because the first virtual object is directly generated when needed, and does not need to be generated in the development phase of the game application, difficulty in game development can be reduced, and game development efficiency can be improved. Various and infinite first virtual objects can be generated, whereby limitation of the game application is reduced, and scalability of the game application is improved.

In an example, the term “random” refers to a process or selection that is performed in a manner such that the outcome is not predetermined or fixed, and each possible outcome has a probability of being selected according to a specified distribution or set of rules. “Random” may include, but is not limited to, selection based on uniform probability, weighted probability, or other algorithmic or procedural methods that introduce unpredictability or variability into the selection or generation process. The term “random” as used herein is intended to encompass any method or process that results in non-deterministic, unpredictable, or variable outcomes, whether by true randomness, pseudo-random algorithms, or other procedural generation techniques, unless otherwise specified.

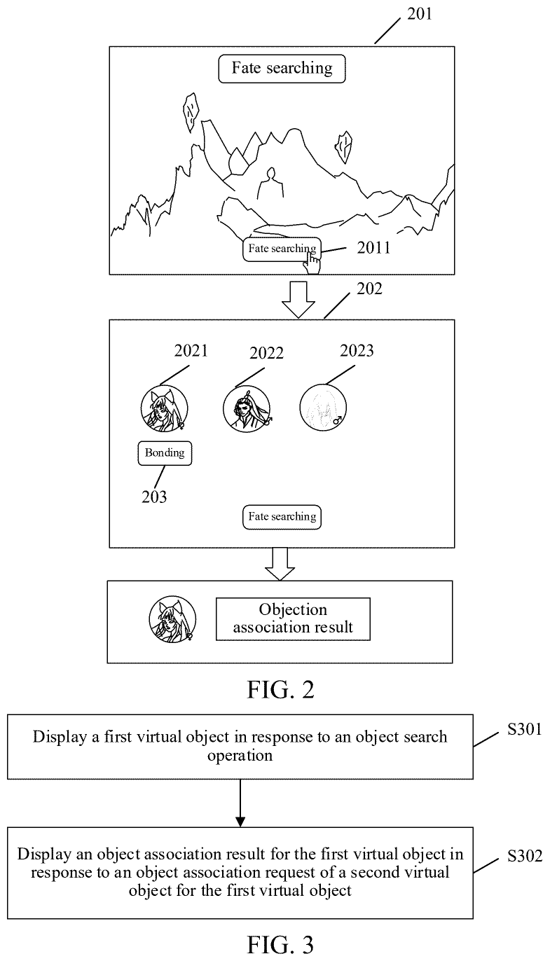

Specifically, FIG. 2 is a schematic diagram of a game processing scene according to an aspect of this disclosure. As shown in FIG. 2, a computer device may display a first virtual object in response to an object search operation. The first virtual object may be generated according to a first object keyword. The first object keyword is acquired from a keyword set based on the object search operation. That is, an object association function may be triggered in response to the object search operation, the first virtual object is generated based on the object association function, and the first virtual object is displayed. The first virtual object is an intelligently running game object, namely, a non-player character (NPC), which may be considered as an intelligent entity. In an aspect, the object search operation is an operation configured to trigger the object association function. This is not limited in this disclosure. The object association function is configured to establish an association relationship between different virtual objects, and may be a gameplay function in a game application that facilitates interactions between objects, such as bonding mechanics or socializing mechanics. The object association function may be a function for associating and matching an NPC with a player character, and is configured to determine an association between the NPC and the player character, and establish an association relationship between the NPC and the player character upon a success association and match. The object association function is configured to create a bonding mechanics between the player character and the NPC, and may be, for example, an object bonding function. For example, the computer device may display an object search page 201, display an association function component 2011 on the object search page 201, display an object presentation page 202 in response to a trigger operation for the association function component 2011, and display the first virtual object on the object presentation page 202. In this case, the object search operation is a trigger operation for the association function component 2011. The association function component 2011 is a component that is integrated in the object search page 201 and is configured to trigger searching for a virtual object. That is, the association function component 2011 may be a component that is located on a presentation page (namely, the object search page 201) of the object association function and is configured to trigger the object association function. Alternatively, the computer device may display the object presentation page 202 in response to a trigger operation for a second association component in the game application, and display the first virtual object on the object presentation page 202. In this case, the object search operation is a trigger operation for the second association component in the game application, and the second association component is a component integrated in a functional area of the game application, that is, may be a component that can be called out on any game interface of the game application, and is configured to trigger searching for a virtual object. Alternatively, the computer device may display the object search page 201 in response to the trigger operation for the second association component, display the association function component 2011 on the object search page 201, display the object presentation page 202 in response to the trigger operation for the association function component 2011, and display the first virtual object on the object presentation page 202. In this case, the object search operation includes the trigger operation for the second association component, the trigger operation for the association function component 2011, and the like. This is not limited herein. In other words, the computer device may directly enter, based on the second association component, a page (namely, the object search page 201) configured to trigger searching for a virtual object, or may be configured to directly trigger searching for a virtual object. This is not limited herein. The object association function may alternatively be triggered by another object search operation, such as a trigger operation for an object search shortcut key (for example, if the object search shortcut key is Ctrl+Shift+m, the object search operation is an operation in which three keys Ctrl+Shift+m are simultaneously triggered) or a drawing operation for an object search pattern (for example, if the object search pattern is ∞, the object search operation is a drawing operation for co). This is not limited herein. A quantity of first virtual objects is N, and N is a positive integer. For example, as shown in FIG. 2, the first virtual object includes a first virtual object 2021, a first virtual object 2022, and a first virtual object 2023. The game application mentioned in this disclosure is configured to refer to an application program in which an object search operation is triggered, and may be any application program having an object association function, that is, may be any type of game application, such as a role-playing game (RPG) or a card collection game. This is not limited herein.

Further, the computer device may display an object association result for the first virtual object in response to an object association request of a second virtual object for the first virtual object. Specifically, when the second virtual object is successfully associated with the first virtual object, the association success result for the first virtual object is displayed; and when the second virtual object fails to be associated with the first virtual object, an association failure result for the first virtual object is displayed. The second virtual object is a game object controlled by a game operator (namely, a game user or a player), which may be considered as a player character. The object association request for the first virtual object may include a trigger operation for an object association component of the first virtual object, or may include a selection operation for the first virtual object, or may include a designated trigger operation for the first virtual object. This is not limited herein. The designated trigger operation is a preset operation configured to trigger an object association request for a first virtual object, such as a double-tap operation or a long-press operation. When the quantity of first virtual objects is not one, the object association request may be triggered for any one of the first virtual objects. For example, as shown in FIG. 2, a description is made using an example in which the object association request for the first virtual object includes a trigger operation for the object association component of the first virtual object. The computer device may associatively display an object association component for each first virtual object, for example, associatively display an object association component 203 for the first virtual object 2021. The computer device may display an object association result for the first virtual object for the first virtual object in response to a trigger operation for the object association component 203. Therefore, a process of associating with a virtual object has high autonomy and flexibility.

The computer device mentioned in the aspects of this disclosure includes, but is not limited to, a terminal device or a server. In other words, the computer device may be a server or a terminal device, or may be a system including a server and a terminal device. The terminal device mentioned above may be an electronic device, which includes, but is not limited to, a mobile phone, a tablet computer, a desktop computer, a notebook computer, a palmtop computer, an on-board device, an augmented reality/virtual reality (AR/VR) device, a helmet display, a smart television, a wearable device, a smart speaker, a digital camera, a camera, and another mobile internet device (MID) having a network access capability, or a terminal device in scenarios such as a train, a ship, and an aircraft. As shown in FIG. 1, the terminal device may be a notebook computer (such as the service device 102b), a mobile phone (such as the service device 102c), an on-board device (such as the service device 102a), or the like. FIG. 1 merely shows some devices. In an aspect, the service device 102a is a device located in a vehicle 103. The service device 102a may be configured to run a game application such as a game application 1021. The server mentioned above may be an independent physical server, a server cluster or distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, vehicle infrastructure cooperation, a content delivery network (CDN), and a big data and AI platform.

In an aspect, the data involved in the aspects of this disclosure may be stored in a computer device, or may be stored by a cloud storage technology or a blockchain network. This is not limited herein.

Further, FIG. 3 is a flowchart of a game processing method according to an aspect of this disclosure. As shown in FIG. 3, the game processing process includes the following operations.

Operation S301: Display a first virtual object in response to an object search operation. For example, a virtual object request is received. A first virtual object is obtained in response to the virtual object request. The first virtual object is generated based on a first keyword that is selected from a keyword set and is associated with the first virtual object. The first virtual object is displayed.

In the aspects of this disclosure, the first virtual object is generated according to a first object keyword, and the first object keyword is acquired from a keyword set based on the object search operation. That is, the first virtual object is generated based on the acquired first object keyword. The first virtual object is an intelligently running game object, which may be considered as an intelligent entity, is AI that is set and generated based on the first object keyword, namely, an NPC, or is configured to play an NPC. Because the first virtual object is randomly generated, or in various manners, different first virtual objects generated at a same moment, or first virtual objects generated at different moments are usually different. That is, a probability that different first virtual objects are identical is quite low, which makes each search for the first virtual object akin to opening a mystery box. Furthermore, each first virtual object may be a unique and limited edition. Therefore, a result of an object association function is unknown and infinite to a game user, which improves scalability, playability, diversity of a game. The keyword set includes a plurality of keywords configured to generate virtual objects.

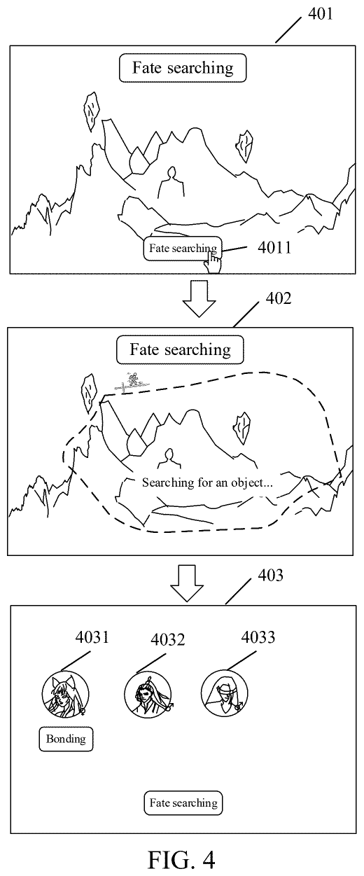

Specifically, a computer device may display an object search waiting page in response to the object search operation; and display the first virtual object when the first virtual object is generated based on the object search operation. The object search waiting page is configured to wait for generation of the first virtual object. For example, FIG. 4 is a schematic diagram of object generation according to an aspect of this disclosure. As shown in FIG. 4, the computer device may display an object search waiting page 402 in response to the object search operation. For an example of the object search operation, reference can be made to the related descriptions in FIG. 2. For example, as shown in FIG. 4, the object search waiting page 402 is displayed in response to a trigger operation for an association function component 4011 on an object search page 401. Details are not described herein again. In an aspect, a search prompt message may be displayed on the object search waiting page 402, such as “Searching for an object . . . ” or “Searching for a density . . . ” shown in FIG. 4. Alternatively, search media data may be displayed on the object search waiting page 402. The search media data may be an object search animation, or data including a static background and a dynamic loading animation (such as an animation of a sword-riding man flying along a dotted line shown in FIG. 4). Alternatively, the search prompt message and the search media data may be both displayed on the object search waiting page 402. Alternatively, content displayed on the object search waiting page 402 may be determined according to a game application, such as a default transition image of the game application, or may be generated by a developer of the game application. This is not limited herein. The default transition scene is an image displayed when a game map is switched in the game application. When the first virtual object is generated based on the object search operation, the first virtual object may be displayed. Specifically, the object search waiting page 402 may be switched to an object presentation page 403, and the first virtual object is displayed on the object presentation page 403. A quantity of first virtual objects is N, and N may be a positive integer. For example, as shown in FIG. 4, the first virtual object includes a first virtual object 4031, a first virtual object 4032, and a first virtual object 4033. In addition to the first virtual object, other needed data may further be displayed on the object presentation page 403. In this disclosure, only content involved in this disclosure is described, but there is no limitation on displaying other content on each page mentioned in this disclosure.

In an aspect, when displaying the object search waiting page, the computer device may close the object search waiting page in response to a page closing operation for the object search waiting page, and stop responding to the object search operation, that is, end the object association function. In this manner, closing the object search waiting page is considered as stopping searching for a virtual object. The game user may stop an object searching process when it takes an excessively long time to search for the first virtual object, to prevent excessive time consumption from reducing playability and fun, performance, and the like of the game. Alternatively, a first game interface may be displayed in response to the page closing operation for the object search waiting page, and a first association component is displayed on the first game interface. The first game interface is an interface for interaction in the game application. In an aspect, in this process, the first game interface is switched to a game switching interface requested by a page switching operation if there is the page switching operation for a second virtual object, and the first association component is displayed on the game switching interface. In this case, the operation that when the first virtual object is generated based on the object search operation, the first virtual object is displayed is specifically implemented as follows: when the first virtual object is generated based on the object search operation, search completion data is displayed for the first association component; and the first virtual object is displayed in response to a trigger operation for the first association component.

In other words, the first association component is a component configured to return a related page of the object association function, that is, displayed on a game interface currently displayed by the game application during generation the first virtual object. In other terms, the first association component may be displayed on any game interface, and is configured to indicate that the first virtual object is being generated or has been generated. When running of the object association function is ended, displaying of the first association component may be stopped. For example, after the first virtual object is displayed, if an opening operation for a third game interface is detected, a third game interface is displayed in response to the opening operation for the third game interface. In this case, the first association component may be not displayed on the third game interface. In short, the first association component means that during running of the object association function, if the game user would like to do another thing at the same time, such as performing a game task, the first association component may be displayed, and the game user can return to display a running condition of the object association function from any game interface and any game scene through the first association component. In an aspect, if the first association component is displayed in a first game scene and the first game scene cannot be exited midway, the first association component may be displayed in a form that can only be displayed but cannot be triggered. Specifically, display and update may be performed according to a requirement of the game application. This is not limited herein. That is, in this manner, searching for a virtual object is not stopped when the object search waiting page is closed, but the object association function runs in a backend of the game application. In this way, the object association function runs in parallel with another operation of the game user. Therefore, searching for a virtual object does not affect normal game experience of the game user. In particular, because the first virtual object is generated instantly in response to the object search operation, a case of relatively long generation time may exist. In this manner, game experience of the game user is improved, and playability and performance of the game are improved.

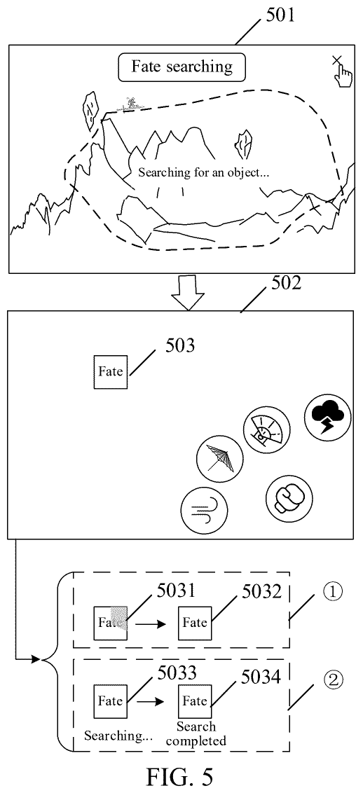

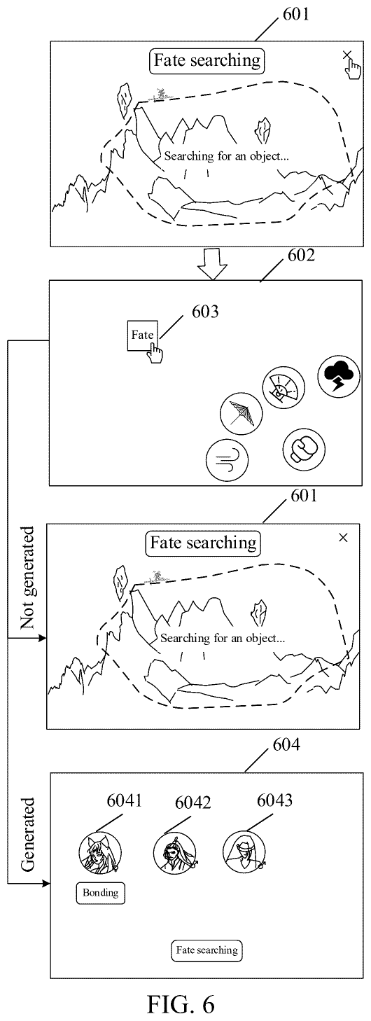

For example, FIG. 5 is a schematic diagram of game scene switching according to an aspect of this disclosure. As shown in FIG. 5, a computer device may display a first game interface 502 in response to a page closing operation for an object search waiting page 501. A first association component 503 is displayed on the first game interface 502. The first association component is a component configured to indicate that an object association function runs in a backend. In this case, when a first virtual object is generated based on an object search operation, search completion data is displayed for the first association component 503. The search completion data is configured to characterize that searching for the first virtual object is completed, and may be an identifier, text information, or the like. For example, in a possible manner (1) in FIG. 5, the search completion data is a completion identifier, which may be a mask (such as a grayscale mask shown by a first association component 5031 in a searching state) added to the first association component 503. When the first virtual object is generated based on the object search operation, the mask is canceled (for example, shown by a first association component 5032 in a search completion state) for the first association component 503. In this case, the search completion data may be considered as unmask data. For example, in a possible manner (2) in FIG. 5, the search completion data is text information, which may be search prompt data associatively displayed by the first association component 503, such as search prompt data “Searching for . . . ” shown by the first association component 5033 in the searching state. When the first virtual object is generated based on the object search operation, the search completion data is displayed for the first association component 503, such as search completion data “Search completed” shown by the first association component 5034 in the search completion state. For examples of the searching state and the search completion state, reference can be made to component states of the first association component. In an aspect, the first association component is displayed when the first virtual object is searched for, and the first association component is canceled after being triggered. Further, the first virtual object may be displayed in response to a trigger operation for the first association component, such as the first association component 5032 or a first association component 5034. Specifically, FIG. 6 is a schematic diagram of an object search scene according to an aspect of this disclosure. As shown in FIG. 6, a computer device displays a first game interface 602 in response to a page closing operation for an object search waiting page 601. A first association component 603 is displayed on the first game interface 602. A searching condition for a first virtual object is acquired in response to a trigger operation for the first association component 603. If the first virtual object is not generated, an object search waiting page 601 is displayed. If the first virtual object is generated based on an object search operation, the first virtual object is displayed. Specifically, an object presentation page 604 may be displayed, and the first virtual object, such as a first virtual object 6041, a first virtual object 6042, and a first virtual object 6043, is displayed on the object presentation page 604.

In an aspect, the first game interface is a default game interface of the game application, a game interface on which the game user stays before opening the object search waiting page, or the like. This is not limited herein. For example, as shown in FIG. 5, when displaying the first game interface 502, the computer device displays the object search waiting page 501 in response to the object search operation; and further, returns to display the first game interface 502 in response to the page closing operation for the object search waiting page 501.

In an aspect, the first game interface is displayed in response to the page closing operation for the object search waiting page. If the first virtual object is not generated, the object search waiting page is displayed in response to a trigger operation for a second association component displayed on the first game interface; and if the first virtual object is generated based on the object search operation, the process of displaying the first virtual object in response to the trigger operation for the second association component displayed on the first game interface is performed. The second association component may be a function component integrated in the game application, which may be integrated in a function display area of the game application. The second association component may be directly displayed in the function display area. Alternatively, the second association component may be integrated in the function display area. The second association component may be integrated in the function display area in a hidden state or a display state. The display state refers to a state that can be directly viewed by the game user, and the hidden state refers to a state that cannot be directly viewed by the game user. In this case, the second association component may be displayed in response to an unfolding operation for the function display area. In this way, the second association component is in the display state. The second association component is also configured to trigger the object association function. The second association component is directly integrated in the game application, is a basic function component of the game application, is similar to a function component configured to trigger each game task and the like in the game application, is equivalent to a global function component, and may be configured to trigger the object association function and the like. For example, when function components of the game application are displayed at the upper right corner of the game application, the function components may include the second association component.

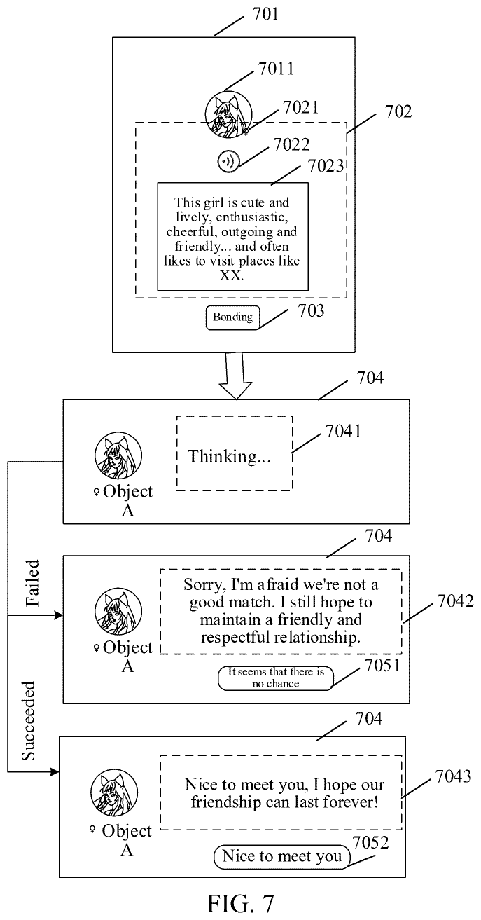

Further, a first object avatar and first object information may be displayed for the first virtual object, that is, the first object avatar and the first object information are displayed in a same area. In this way, the game user can intuitively view the first object avatar and the first object information. The first object avatar and the first object information belong to a same first virtual object. The first object avatar and the first object information are generated based on the acquired first object keyword. The first object information is configured to describe the first virtual object. In a related game application, an NPC is directly generated in the development phase of a game, that is, when needing to interact with the NPC, the game user may directly acquire the NPC. The NPC is an indispensable component of the game application, which also ensures normal running of the game application. In this disclosure, the NPC may be expanded based on the game application, and when interaction with the NPC is needed, the first virtual object is directly generated based on the acquired first object keyword, which includes, but is not limited to, generation of the first object avatar, the first object information, and the like of the first virtual object, to construct an NPC (the first virtual object in this disclosure) that is unknown before generation. In this way, the game application is not limited to run in a game world constructed by the developer, and may be further be intelligently expanded. Therefore, scalability and running flexibility of the game application are improved, and playability is also improved to an extent. In an aspect, the first object information includes a first object speech and the like. The first object speech is played in response to a trigger operation for the first object speech. Specifically, FIG. 7 is a schematic diagram of an object association scene according to an aspect of this disclosure. As shown in FIG. 7, a computer device may display a first virtual object on an object presentation page 701, and associatively display a first object avatar 7011 and first object information 702 for the first virtual object. The first object information 702 may include, but is not limited to, a first object attribute 7021, a first object name, a first object speech 7022, first object description data 7023, and the like. The first object attribute 7021 is configured to represent an attribute of the first virtual object, such as a game gender. The first object name is configured to represent a game name of the first virtual object, that is, a name used by another NPC or the game user to call it. The first object speech 7022 is a speech provided by the first virtual object to the outside, and is configured to, for example, greet the game user or introduce the first object. For example, the first object speech 7022 is a speech corresponding to “Hello, I am XXX. It is fate that we meet today”, or is a speech corresponding to the first object description data 7023. The first object speech 7022 is generated based on the first object keyword. The first object description data 7023 may be configured to describe basic information of the first virtual object, such as a game position, a personality introduction, or a daily introduction corresponding to the first virtual object in the game application. In an aspect, a quantity of first virtual objects is N. For an example of each first virtual object, reference can be made to the foregoing description.

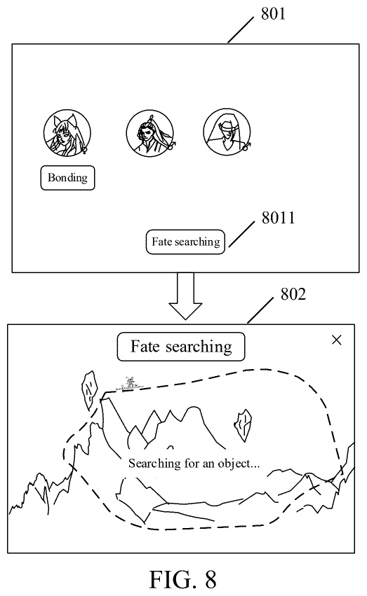

Further, a third association component may be displayed. The third association component is a component displayed on the object presentation page, and is configured to re-trigger a process of searching for an object, that is, re-invoke the object association function. The third association component is configured to trigger the object association function, that is, re-trigger the process of generating the first virtual object, is a function component displayed on a display interface of the first virtual object, and is configured to re-trigger the object association function after a running result (that is, the first virtual object) of the object association function is generated. That is, after the first virtual object is generated, if the game user would like to search for a new first virtual object, and would not like to associate with the currently generated first virtual object, or completes association with the currently generated first virtual object, the third association component may be triggered, and the object association function is re-invoked. In this way, the game user can quickly and conveniently search for a new first virtual object. Therefore, flexibility of triggering a game function is improved. Specifically, the object search waiting page may be displayed in response to a trigger operation for the third association component. In this case, the object search waiting page is configured to wait for regeneration of the first virtual object. A process after the third association component is triggered is the same as the foregoing process after the object search operation is triggered, and details are not described herein again. For example, FIG. 8 is a schematic diagram of an object re-search scene according to an aspect of this disclosure. As shown in FIG. 8, a computer device may display an object search waiting page 802 in response to a trigger operation for a third association component 8011 displayed on an object presentation page 801. Alternatively, an unassociated object may be deleted from the first virtual object in response to the trigger operation for the third association component. The unassociated object is a first virtual object that is not associated with the second virtual object. For example, the first virtual object includes a virtual object A, a virtual object B, and a virtual object C, the virtual object A is associated with the second virtual object, and the unassociated object refers to the virtual object B and the virtual object C. The second virtual object is a virtual object triggering the object search operation, which may be considered as a character controlled by the game user.

In an aspect, if the computer device detects a closing operation for the object presentation page, the computer device may delete the unassociated object from the first virtual object in response to the closing operation for the object presentation page. This is equivalent to that if the game user closes the object presentation page, which is considered by default that the game user gives up object association with the first virtual object on the object presentation page, the first virtual object not associated with the second virtual object, namely, the unassociated object, may be deleted. In this way, each generated first virtual object may be a unique and limited edition, and the game user has high expectations each time before viewing the generated first virtual object. Therefore, playability and user stickiness of the game application are improved. In addition, because the first virtual object is directly generated each time, the space occupation of the game application can be reduced by deleting the unassociated object.

Operation S302: Display an object association result for the first virtual object in response to an object association request of a second virtual object for the first virtual object. For example, in response to an object association request, an indication that the first virtual object is associated with a second virtual object when the second virtual object controlled by a user is associated with the first virtual object is displayed.

In the aspects of this disclosure, the computer device may display an association waiting message in response to the object association request of the second virtual object for the first virtual object. The object association request is configured to request establishment of an association relationship with the first virtual object. The association waiting message is a message displayed when association determination is performed on the second virtual object and the first virtual object is determined, such as “Associating . . . ”. The association determination refers to detection of whether an association is performed on the second virtual object and the first virtual object. When association is completed, the object association result of the first virtual object and the second virtual object is displayed. The object association result includes an association success result and an association failure result, the association success result is configured to represent that the second virtual object is successfully associated with the first virtual object, and the association failure result is configured to represent that the second virtual object is not associated with the first virtual object. Specifically, the quantity of first virtual objects is N, and N is a positive integer. The computer device may display the association waiting message in response to the object association request for a target virtual object in the N first virtual objects. If the second virtual object fails to be associated with the target virtual object, a failure prompt message for the target virtual target is displayed, and a failure confirmation component is displayed. That is, in this case, the association failure result includes, but is not limited to, the failure prompt message, the failure confirmation component, and the like. If the second virtual object is successfully associated with the target virtual object, a success prompt message for the target virtual object is displayed, and a success confirmation component is displayed. That is, in this case, the association success result includes, but is not limited to, the success prompt message and the success confirmation component. That is, as shown in FIG. 7, an association component 703 is associated with the first virtual object. The object association component 703 is a component configured to trigger the object association request for the associated first virtual object. That is, object association components are respectively associated with the N first virtual objects. A description is made by using an example in which the target virtual object is a first virtual object 7011, the computer device may display an association management page 704 for the first virtual object 7011 in response to an object association request for the first virtual object 7011. The object association request may be generated based on a trigger operation for the object association component 703 associated with the first virtual object 7011. The association management page 704 may be a page (such as a floating window) independently displayed on the object presentation page 701, or may be an area displayed on the object presentation page 701. This is not limited herein. The computer device may display an association waiting message 7041, such as “Thinking about . . . ”. If the association with the first virtual object 7011 fails, a failure prompt message 7042 of the first virtual object 7011 may be displayed on the association management page 704. In an aspect, a failure confirmation component 7051 is further displayed. If the association with the first virtual object 7011 succeeds, a success prompt message 7043 of the first virtual object 7011 may be displayed on the association management page 704. In an aspect, a success confirmation component 7052 is further displayed.

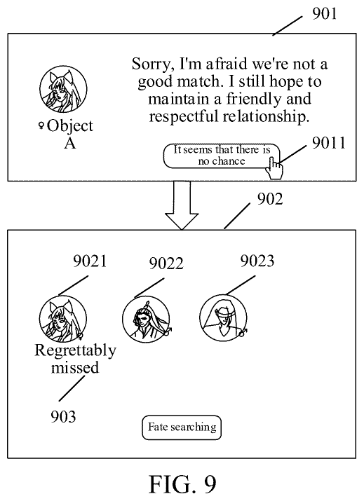

Further, in an aspect, when the second virtual object fails to be associated with the target virtual object, the computer device may return to display the N first virtual objects, that is, return to display the object presentation page, in response to a trigger operation for the failure confirmation component. In an aspect, an association failure message is associatively displayed for the target virtual object. The association failure message is configured to indicate that the object association request cannot be triggered for the target virtual object, and may be a message such as “Regrettably missed” or “Failed to bond”. In an aspect, displaying of the object association component associated with the target virtual object is canceled. For example, FIG. 9 is a schematic diagram of an association scene according to an aspect of this disclosure. As shown in FIG. 9, a computer device may return to display an object presentation page 902 in response to a trigger operation for a failure confirmation component 9011 on an association management page 901. The first virtual object, such as a first virtual object 9021, a first virtual object 9022, and a first virtual object 9023, is displayed on the object presentation page 902. It is assumed that the first virtual object 9021 is the target virtual object fails to be associated with the second virtual object, an association failure message 903, such as “Regrettably missed”, may be associatively displayed for the first virtual object 9021.

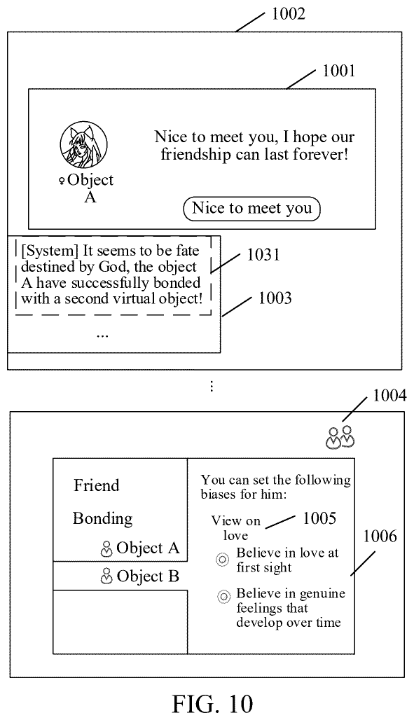

Further, in an aspect, when the second virtual object is successfully associated with the target virtual object, the object association message between the target virtual object and the second virtual object may be outputted in a system notification area. The system notification area is an area configured to display a game system notification, such as an area configured to publish the game system notification in the game application, and may further include a notification bar of the game application. It may be considered that a message displayed in the system notification area is published by the game application, and cannot be edited by the game user. For example, FIG. 10 is a schematic diagram of another association scene according to an aspect of this disclosure. As shown in FIG. 10, it is assumed that an association management page 1001 is a page independently displayed on an object presentation page 1002, an object association message 1031 between the first virtual object and the second virtual object, namely, the object association message between the target virtual object and the second virtual object, may be outputted in a system notification area 1003. The object association message 1031 is configured to represent that the target virtual object is successfully associated with the second virtual object. For example, it is assumed that the target virtual object is an object A, the object association message 1031 may be, for example, “It seems to be fate destined by God, the object A has successfully bonded with the second virtual object!”. “[System]” is configured to represent that the message is published by the game application. The system notification area 1003 may be displayed on any game interface, and a display location of the system notification area 1003 on each game interface is not limited. In an aspect, the computer device returns to display the N first virtual objects in response to a trigger operation for the success confirmation component. Alternatively, the computer device displays a second game interface in response to the trigger operation for the success confirmation component if a first associated object in the N first virtual objects is greater than or equal to a unit association threshold; and returns to display the N first virtual objects if the first associated object in the N first virtual objects is less than the unit association threshold. The first associated object is a first virtual object, associated with the second virtual object, in the N first virtual objects. That is, when the first virtual object is generated once, at most, the unit association threshold of first virtual objects can be associated once. For example, the unit association threshold is 2, and a quantity of first associated objects in the N first virtual objects is 2. In this case, the quantity of first associated objects in the N first virtual objects is equal to the unit association threshold, and the second game interface is displayed in response to the trigger operation for the success confirmation component. The second game interface may be a default game interface of the game application, a game interface on which the game user stays before opening the object search waiting page, or the like. The second game interface may be the same as the first game interface or may be different from the first game interface.

In an aspect, if the second virtual object is successfully associated with the target virtual object, a game object list is displayed in response to a viewing operation for the game object list of the second virtual object, such as a trigger operation for a contact object component 1004. The game object list includes a second associated object of the second virtual object. The second associated object is a virtual object associated with the second virtual object. The second associated object is an intelligently running game object, that is, may be considered as an intelligent entity, and is an NPC. The second associated object includes the target virtual object. Specifically, the second associated object includes the first associated object in the N first virtual objects, a historical virtual object previously associated with the second virtual object, and the like, such as a friend subset and an association subset shown in FIG. 10. Alternatively, the second associated object may be displayed in a same subset. The game object list may include all first associated objects of the second virtual object, such as the target virtual object. In an aspect, a session page with the target virtual object is displayed in response to a session request for the target virtual object; and an object topic bias option of the target virtual object is displayed on the session page with the target virtual object. The object topic bias option includes M object topic biases, and M is a positive integer. For example, an object topic bias option 1005 shown in FIG. 10 includes M object topic biases 1006. The object topic bias option 1005 is configured to represent a possible bias of the target virtual object for one object topic, namely, different ideas (or opinions) for one object topic. The object topic refers to a topic type of session communication, such as a view on love, a travel destination, a game, or another topic. Further, a first object topic bias may be associated with the target virtual object in response to a selection operation for the first object topic bias of the M object topic biases. The first object topic bias is a basis on which the target virtual object subsequently generates a session message for the object topic, that is, the session message generated by the target virtual object for the object topic conforms to the first object topic bias. In this case, if a session is performed with the target virtual object for the object topic, the target virtual object generates, based on the first object topic bias, a session message to be transmitted to the second virtual object. The M object topic biases are configured to represent different ideas for one object topic. For example, it is assumed that the object topic is a travel destination, the M object topic biases include, but are not limited to, “Like famous tourist attractions”, “Like to travel at will”, “Like beautiful but less famous places”, and the like. It is assumed that the first object topic bias associated with the target virtual object is “Like beautiful but less famous places”, when performing a session with the target virtual object for the travel destination, the computer device generates, based on “Like beautiful but less famous places”, a session message to be replied to the second virtual object. For example, after “The holiday is coming, I really want to go out and play” transmitted by the second virtual object is received, the session message to be replied to the second virtual object may be generated based on the “Like beautiful but less famous places”, such as “There are too many people in those scenic spots during the holidays. It is better to go to some remote places, such as XXX, which is quite good”. By configuring the object topic bias to the target virtual object, a more real association with the game user may be established to an extent, whereby reality of communication is improved. In addition, the game user may further acquire some indication, suggestion, or the like from the target virtual object through the object topic bias to an extent, whereby the depth of the game is increased. To avoid guiding the game user, a suggestion prompt message may be generated at the same time, such as a prompt “This is just a little suggestion from me, you can use it as a reference”. Alternatively, the game user may set the first object topic bias for the object topic to his or her opinion. In this way, the target virtual object and the game user have a same object topic bias for the object topic. Therefore, smoothness of a session between the target virtual object and the second virtual object is improved.

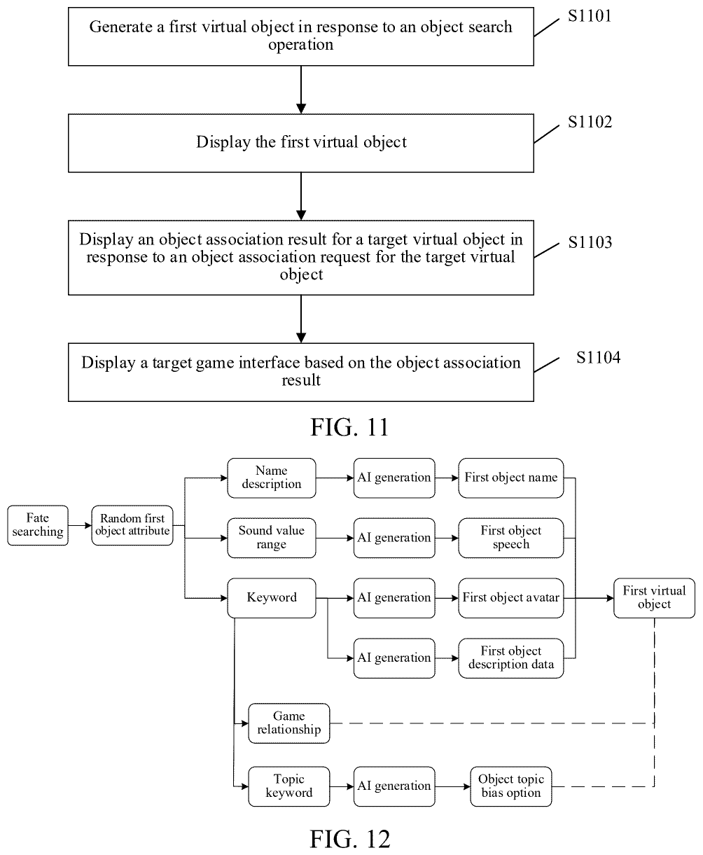

Further, FIG. 11 is a flowchart of a specific implementation of a game processing method according to an aspect of this disclosure. As shown in FIG. 11, the game processing process includes the following operations.

Operation S1101: Generate a first virtual object in response to an object search operation. For example, the first virtual object is generated based on a first keyword that is selected from a keyword set and is associated with the first virtual object.

In the aspects of this disclosure, a computer device generates the first virtual object in response to the object search operation. For an example of a display condition of a page during generation the first virtual object, reference can be made to the related descriptions of operation S301 in FIG. 3. Details are not described herein again. Specifically, when generating the first virtual object, the computer device may determine, for example randomly or in various manners, a first object attribute, and generate a first object name based on the first object attribute. An object attribute (such as the first object attribute and a second object attribute) is configured to represent a component of a virtual object, which is configured to characterize a basic feature of the virtual object, such as object gender and object age. Specifically, FIG. 12 is a schematic diagram of a virtual object generation scene according to an aspect of this disclosure. As shown in FIG. 12, the first object attribute may be randomly determined, a name description library associated with the first object attribute is acquired, a name description is randomly determined from the name description library, the name description is transmitted to object generation AI, and the object generation AI is invoked to generate the first object name based on the name description. Further, a first keyword set associated with the first object attribute may be acquired from a keyword set, that is, the keyword set includes a plurality of keywords, keywords that may be applied to the first object attribute may be acquired from the plurality of keywords included in the keyword set, and the keywords that may be applied to the first object attribute form the first keyword set. In an aspect, a second keyword set associated with the second object attribute may be acquired from the keyword set based on the second object attribute. Because some keywords may be applied to different object attributes, some keywords in the first keyword set and the second keyword set may be the same. The first keyword set includes K keywords, as well as object categories and phrase weights that respectively correspond to the K keywords. Specifically, Table 1 is some possible schematic data of keywords in this disclosure:

TABLE 1
First object attribute keyword

| Object general | Object sub- | | Phrase |
|---|---|---|---|
| category | category | Keyword | weight |
| 1 | 1 | Long hair | 10 |
| 1 | 1 | Short hair | 10 |
| 1 | 1 | Long plait | 10 |
| 1 | 1 | Ponytail | 10 |
| 1 | 2 | Large eyes | 10 |
| 1 | 2 | Small eyes | 10 |
| 1 | 3 | Double eyelid | 10 |
| 1 | 3 | Single eyelid | 10 |
| 2 | 2 | Human tribe | 10 |
| 2 | 2 | Fox tribe | 2 |
| 2 | 3 | Tall and big | 10 |
| 2 | 3 | Short and small | 10 |
| . . . | . . . | . . . | . . . |

As shown in Table 1, the object category includes an object general category and an object sub-category. For example, in Table 1, an object category of the keyword “long hair” is “object general category: 1, and object sub-category: 1”, and a phrase weight is 10. The object general category is configured to represent a general category to which a corresponding keyword belongs, and the object sub-category is configured to represent a specific category to which a corresponding keyword belongs. As shown in Table 1, the object general category “1” is configured to represent an object appearance type, the object sub-category “1” in the object general category “1” is configured to represent a hair type, the object sub-category “2” in the object general category “1” is configured to represent an eye type, and the object sub-category “3” in the object general category “1” is configured to represent an eyelid type. The object general category “2” is configured to represent a type affecting a figure, the object sub-category “2” in the object general category “2” is configured to represent a racial type, and the object sub-category “3” in the object general category “2” is configured to represent a height type. Table 1 above is merely an example of several possible keywords.

Further, the first object keyword may be selected, for example randomly or in various manners, from the K keywords according to the object categories and phrase weights that respectively correspond to the K keywords. The first virtual object is generated according to the first object keyword. Specifically, a keyword invoking rule may be acquired, and the first object keyword is randomly selected from the K keywords based on the keyword invoking rule, as well as the object categories and phrase weights that respectively correspond to the K keywords. That is, the first object keyword is randomly selected from keywords in a same object category based on the phrase weights respectively corresponding to the K keywords. For an example of the keyword invoking rule, reference can be made to Table 2:

TABLE 2

| | Object | Sub- | | Sub- | Random |
|---|---|---|---|---|---|
| Object | general | category | | category | quantity of |
| parameter | category | 1 | . . . | P | sub-categories |
| Avatar | 1 | 1 | . . . | | |
| Avatar | 1 | 2 | . . . | | |
| Avatar | 1 | 3 | . . . | | |
| Avatar | 2 | 1 | . . . | 5 | 2 |
| Topic | 3 | 1 | . . . | | 1 |
| . . . | . . . | . . . | . . . | . . . | . . . |

As shown in Table 2, the keyword invoking rule may include t invoking items, and t is a positive integer. Each invoking item is configured to represent an object category from which a keyword is selected for an object parameter. As shown in Table 2, when a first object avatar is generated, an avatar invoking item associated with the object parameter “avatar” may be acquired. By adopting the avatar invoking item, an avatar keyword is selected from an object category indicated by the avatar invoking item. Similarly, a keyword corresponding to each object parameter may be acquired. The random quantity of sub-categories refers to a quantity of keywords selected from a corresponding object category for the invoking item. For example, for the object parameter “topic”, one object keyword is selected from the object category indicated by “object general category: 3, and object sub-category: 1” as a keyword of the object parameter “topic”. Keywords corresponding to the object parameters form the foregoing first object keyword. Object categories corresponding to different object parameters may have an overlapping part, or may be different from each other. For example, it is assumed that the first object keyword is shown in Table 3:

TABLE 3
Random result

| Type | Sub-category | First object keyword |
|---|---|---|
| 1 | 1 | Short hair |
| 1 | 2 | Large eyes |
| 1 | 3 | Double eyelid |
| 2 | 1 | Mature human |
| 2 | 2 | Fox tribe |
| 2 | 3 | Short and small |
| 2 | 4 | Delicate skin |
| 2 | 5 | Yellow skin |

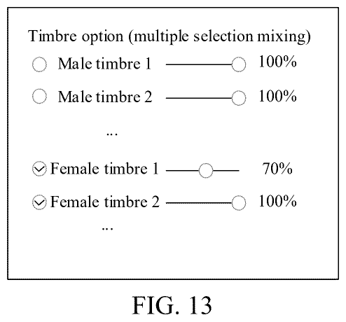

The first virtual object may be generated according to the first object keyword. Specifically, the first object keyword is rendered into the first virtual object. For example, the first object keyword includes, but is not limited to, “long hair, curly hair, big eyes, fox tribe, delicate skin, and the like”, and the first object keyword is rendered into the first virtual object. In this case, the first virtual object is a fox tribe girl having long curly hair and big eyes, and the fox tribe girl has delicate skin, and the like. Specifically, the first object avatar may be generated according to the first object keyword. That is, a head-associated phrase in the first object keyword may be rendered into the first object avatar. As shown in FIG. 12, a keyword of the object parameter “avatar” in the object keyword may be transmitted to the object generation AI, and the object generation AI is invoked to generate the first object avatar. A game world background of a game application is acquired, and first object description data and object initial data are generated according to the first object keyword and the game world background. Data description integration may be performed on the first object keyword and the game world background to generate the first object description data and the object initial data. The first object description data is configured to represent an introduction to the first virtual object, the object initial data is configured to represent session data provided by the first virtual object to a second virtual object, and the second virtual object is a virtual object triggering the object search operation. Specifically, the first object keyword and the game world background may be transmitted to the object generation AI, and the object generation AI may generate the first object description data based on the first object keyword and the game world background, to describe the first virtual object. A timbre option corresponding to the first object attribute is acquired, a first object timbre is randomly selected from the timbre option, and a first object speech is generated for the object initial data according to the first object timbre. That is, speech conversion is performed on the object initial data based on the first object timbre, to generate the first object speech. FIG. 13 is a schematic diagram of a timbre selection scene according to an aspect of this disclosure. As shown in FIG. 13, the timbre option, such as a male timbre 1, a male timbre 2, . . . and a female timbre 2, corresponding to the first object attribute is obtained, and the first object timbre is randomly selected from the timbre option. A quantity of first object timbres may be one or at least two, such as the female timbre 1 and the female timbre 2 shown in FIG. 13. In an aspect, a volume of the first object timbre may further be randomly set. For example, a volume of the female timbre 1 is randomly set to 70%, a volume of the female timbre 2 is randomly set to 100%, and the female timbre 1 with the volume of 70% may be mixed with the female timbre 2 with the volume of 100%. That is, when the quantity of first object timbres is at least two, the at least two first object timbres may be mixed, to obtain a second object timbre, and the first object speech of the object initial data is generated based on the second object timbre. Further, the first virtual object may be formed based on the first object avatar, the first object description data, the first object speech, and the like. That is, the first virtual object may further include other content, which may be added as needed. This is not limited herein. For example, the first virtual object may further include an object stereoscopic model, an object card, and the like. For example, the first object keyword may be transmitted to the object generation AI, and the first object keyword is rendered into the object stereoscopic model by using the object generation AI. The object stereoscopic model may be a three-dimensional (3D) model. A plane image may be further clipped from the object stereoscopic model, and the object card is formed based on the clipped plane image. This is not limited herein.

In an aspect, when the first object timbre is selected, the first object timbre may be determined based on a timbre weight of each timbre option. In an aspect, the timbre weight is shown in Table 4:

TABLE 4

| Timbre quantity | Quantity weight |
|---|---|
| 1 | 40 |
| 2 | 60 |
| 3 | 40 |
| . . . | . . . |

As shown in Table 4, the computer device may randomly determine a target timbre quantity q based on the quantity weight of each timbre quantity, q being a positive integer; and randomly select q first object timbres from the timbre option corresponding to the first object attribute, or randomly select q first object timbres from the timbre option corresponding to the first object attribute based on the timbre weight of the timbre option corresponding to the first object attribute.

In an aspect, when the first object keyword is transmitted to the object generation AI, the first object keyword is directly transmitted to the object generation AI. Alternatively, the first object keyword may be converted into an AI statement format, to generate an intelligently processed statement. For example, in an implementation, the first object keyword is sorted based on the AI statement format, and the sorted first object keyword is embedded in the AI statement format, to obtain the intelligently processed statement. For example, a possible case is shown in Table 5:

TABLE 5

| | Intelligently processed statement |
|---|---|
| Avatar | Describe a female character in a |
| | game application, who satisfies the |
| | following feature @ XXX |
| Background | Write a background story about an NPC in a |
| description | game application, which includes the following |
| | key information: family |
| | background @ XX, appearance @ XX, |
| | personality @ XX, within 100 words |
| Association | Nice to meet you, I hope our |
| success | friendship can last forever! |
| Association | Sorry, I'm afraid we're not a good match. |
| failure | I still hope to maintain a friendly |
| | and respectful relationship. |

As shown in Table 5 and FIG. 12, the object generation AI may generate related data, such as the first object avatar, the first object description data, and the object topic bias option, of the first virtual object based on the intelligently processed statement.

In an aspect, if a game world in a game application changes, game update content of the game world may be acquired, the first keyword is extracted according to the game update content, and the first keyword is added to a keyword set. Specifically, a first object category corresponding to the first keyword may be acquired, and the first keyword is associatively added to the first object category in the keyword set. The keyword set may include the first keyword set associated with the first object attribute, the second keyword set associated with the second object attribute, and the like. Because some keywords may be common, the first keyword set obtained based on the first object attribute and the second keyword set obtained based on the second object attribute may include a same keyword. For example, the first object attribute is female, and the second object attribute is female. For example, if the first keyword includes “Shura tribe”, the first object category of “object general category: 2, and object sub-category: 2” may be acquired, and the first keyword is added to the keyword set based on the first object category.

In an aspect, a game requirement, a game plan, and the like for the game application are further acquired, a second keyword is determined based on the game requirement and the game plan, a second object category corresponding to the second keyword is acquired, and the second keyword is associatively added to the second object category in the keyword set. The game requirement refers to a requirement put forward by a customer or a game user for the game application, and the game plan refers to an update put forward by a developer of the game application for the game application.

Operation S1102: Display the first virtual object. For example, the first virtual object is displayed.

In the aspects of this disclosure, when generating the first virtual object, the computer device may display the first virtual object. For a specific example of the display process, reference can be made to the related descriptions of operation S301 in FIG. 3.

Operation S1103: Display an object association result for a target virtual object in response to an object association request for the target virtual object. For example, when the second virtual object is associated with the target virtual object, a success prompt message for the target virtual object is displayed. When the second virtual object fails to be associated with the target virtual object, a failure prompt message for the target virtual object is displayed.

In the aspects of this disclosure, for examples of details, reference can be made to the related descriptions of operation S302 in FIG. 3. In an aspect, the computer device acquires an object association probability between the target virtual object and the second virtual object, and performs association determination on the target virtual object and the second virtual object based on the object association probability, to determine the object association result. The object association result includes an association success result and an association failure result. The association success result is configured to represent that the target virtual object is successfully associated with the second virtual object, and the association failure result is configured to represent that the target virtual object fails to be associated with the second virtual object. The target virtual object may be any first virtual object in N first virtual objects. The object association probability is configured to represent a probability that the target virtual object is successfully associated with the second virtual object. For example, it is assumed that the object association probability is 50%, the probability that the second virtual object is successfully associated with the target virtual object is 50%. In an aspect, a default association probability (such as 50%) is determined as the object association probability. Alternatively, a rarity of the target virtual object may be acquired, and the object association probability between the target virtual object and the second virtual object is determined based on the rarity. A higher rarity indicates a lower object association probability. Although the first virtual object is randomly generated, because weights of keywords may be different, generation probabilities of generated first virtual objects are different, that is, rarities are different. Alternatively, second object description data of the second virtual object may be acquired, which includes, but is not limited to, a second object race of the second virtual object, second object faction information, and the like. The object association probability is determined based on an association between the first object description data and the second object description data. For example, if the first virtual object belongs to a fox tribe, and the second object race of the second virtual object is the fox tribe, the association between the first object description data and the second object description data is high. The above are merely examples of methods for determining the object association probability, and does not limit use of another method for determining the object association probability.

Operation S1104: Display a target game interface based on the object association result. For example, when the first associated object count is greater than or equal to a unit association threshold, a second game interface is displayed in response to a trigger operation being performed on a success confirmation component that is displayed when the second virtual object is associated with the target virtual object. When the first associated object count is less than the unit association threshold, the plurality of first virtual objects is displayed.

In the aspects of this disclosure, the target game interface may be displayed based on the object association result. The target game interface may be the foregoing object presentation page, the foregoing association management page, or the like. For an example of details, reference can be made to the related descriptions of operation S302 in FIG. 3.

Further, in an aspect, a game relationship in the game application may be acquired, such as a brother relationship, a sister relationship, a friend relationship, a confidante relationship, or a partner relationship. The first object attribute and the second object attribute of the second virtual object are acquired, and a first game relationship of association between the first object attribute and the second object attribute is acquired from the game relationship. The first game relationship is configured to represent an establishable relationship between the first virtual object and the second virtual object; and the second virtual object is a virtual object triggering the object search operation. A relationship establishment prompt message is displayed when the first virtual object and the second virtual object satisfy an establishment condition of a second game relationship. The first game relationship includes the second game relationship. Specifically, the quantity of first virtual objects is N, it is assumed that the target virtual object and the second virtual object satisfy the establishment condition of the second game relationship, the relationship establishment prompt message may be, for example, “A second game relationship can be established with the target virtual object. Do you want to establish it?”, and the second game relationship may be established for the first virtual object and the second virtual object in response to a relationship establishment operation for the relationship establishment prompt message, that is, the second game relationship is established for the target virtual object and the second virtual object. In an aspect, a relationship identifier of the second game relationship is associatively displayed for the target virtual object. The target virtual object may be any first virtual object that is in the first virtual objects generated for the second virtual object and that is associated with the second virtual object. For example, the game relationship includes, but is not limited to, “brothers, besties, partners, travel companions, friends, and the like”. The game relationship is determined based on the game application. Game relationships in different game applications may be different. For example, the game relationship includes, but is not limited to, “confidants, playmates, chivalrous partners, and sworn brothers or sisters”. This is not limited herein. Establishment conditions of different game relationships may be different, and establishable game relationships between different object attributes may also be different. For example, if the first object attribute includes “male”, and the second object attribute includes “female”, the first game relationship of association with the first object attribute and the second object attribute includes, but is not limited to, “brothers, confidantes, partner, travel companions, friends, and the like”.

For example, the establishment condition of the second game relationship is that the likeability reaches a relationship establishment threshold. The computer device may detect an interaction action between the second virtual object and the target virtual object, accumulate the likeability between the second virtual object and the target virtual object based on the interaction action, until the likeability is greater than or equal to the relationship establishment threshold, determine that the second virtual object and the target virtual object satisfy the establishment condition of the second game relationship, and establish the second game relationship between the second virtual object and the target virtual object. For example, a method for accumulating the likeability includes: a session with the target virtual object is performed, and after a reply message of the target virtual object is received, a first likeability value is added to the second virtual object and the target virtual object. For example, a round-trip messing process in which the second virtual object transmits a message to the target virtual object and receives a reply of the target virtual object is considered as a messaging interaction, and the first good feeling value is added to the second virtual object and the target virtual object for one messaging interaction. Alternatively, in response to a gift giving operation for the target virtual object, a second likeability value is added to the second virtual object and the target virtual object based on a game interaction prop given based on the gift giving operation. The second likeability value is determined based on the game interaction prop, and likeability values corresponding to different game interaction props may be different. Alternatively, when it is detected that the target virtual object and the second virtual object satisfy a gift giving condition, a game prop, such as a buff or a prop, corresponding to the gift giving condition is transmitted to the second virtual object. If a receiving operation of the second virtual object for the game prop is detected, a third likeability value is added to the target virtual object and the second virtual object. The method for accumulating the likeability may not be limited to the foregoing several methods. In an aspect, a likeability acquisition upper limit in unit time may further be set for each method for accumulating the likeability. For example, the likeability is increased twice each day for the gift giving operation for the target virtual object. That is, when the number of times of triggering the gift giving operation for the target virtual object is greater than 2 in one day, the likeability between the second virtual object and the target virtual object is not increased in response to the gift giving operation for the target virtual object.

In an aspect, if non-interaction data between the second virtual object and the target virtual object satisfies a likeability reduction condition, the likeability between the second virtual object and the target virtual object is reduced. For example, if the likeability reduction condition is “No complete message interaction process has been successfully completed for more than 3 days, and no gift interaction has been performed”, on the 4th day, the likeability between the second virtual object and the target virtual object is reduced. In an aspect, the target virtual object is further controlled to transmit a likeability reduction prompt message to the second virtual object. The above establishment of the game relationship between the target virtual object and the second virtual object, the processing of likeability, and the like may be applied to any second associated object and the second virtual object. This is not limited herein. In an aspect, if the second associated object includes at least two likeability reduction objects, one likeability reduction object is randomly controlled to transmit the likeability reduction prompt message to the second virtual object, or the at least two likeability reduction objects are controlled to transmit the likeability reduction prompt message to the second virtual object.

In an aspect, an established relationship that is in the first game relationship and that is established with the second virtual object is acquired, an initiation condition of an associated task is acquired, and if the established relationship satisfies the initiation condition of the associated task, the associated task is initiated for the second virtual object. The game user may participate in the associated task by controlling the second virtual object. A task prop of the associated task is transmitted to the second virtual object when the associated task is completed. For example, the initiation condition of the associated task is that a relationship establishment quantity threshold is reached, and if a quantity of established relationships is greater than or equal to the relationship establishment quantity threshold, it is determined that the established relationship satisfies the initiation condition of the associated task. Alternatively, the established relationship that is in the first game relationship and that is established with the second virtual object may be acquired, relationship establishment data and a game award prop corresponding to the relationship establishment data are acquired, and if the established relationship reaches the relationship establishment data, the game award prop is transmitted to the second virtual object. For example, the relationship establishment data is that d game relationships are established, the likeability between the second virtual object and at least one associated object reaches a likeability threshold, and d is a positive integer, and when the quantity of established relationships is greater than or equal to d, and the likeability between the second virtual object and the at least one associated object is greater than or equal to the likeability threshold, it is determined that the established relationship reaches the relationship establishment data.

In an aspect, when a first session message of the second virtual object is received through the target virtual object, the likeability between the target virtual object and the second virtual object is acquired, and a second session message is replied to the second virtual object based on the likeability between the target virtual object and the second virtual object. For example, higher likeability indicates more intimate tone of the second session message. For example, it is assumed that the first session message is “Hello, long time no see”, when the likeability is relatively low, the second session message is “Haven't seen you for a long time!”; and when the likeability is relatively high, the second session message is “Long time no see, you finally remembered me, is there anything going on recently?” or the like.

In an aspect, this disclosure is further applicable to completion of NPCs in a game scene in the game application. Specifically, if a virtual object of a first object type is missing from the game application, an object missing scene in the game application is acquired, and an application object keyword is acquired based on the first object type and the object missing scene; and a third virtual object is generated according to the application object keyword and is output in the object missing scene. In this case, when entering the object missing scene, the game user may view the third virtual object. In addition, if the third virtual object is an interactive object, the computer device may control, based on an operation of the game user, the second virtual object to interact with the third virtual object. The process of generating the third virtual object is the same as the process of generating the first virtual object. For examples of details, reference can be made to the foregoing description of the process of generating the first virtual object. The first object type refers to an NPC type. It may be considered that the game application includes a game object of the first object type and a game object of a second object type. The second object type refers to a player character, that is, a game object controlled by a game operator. The game operator is the game user (that is, a player).

In an aspect, in the foregoing process, the process of associating with the first virtual object is ended. For example, an object presentation page is closed. First object description data (recorded as second object description data herein) of an unassociated object may be acquired. If the second object description data include a scene that is not expanded in the game world of the game application, associated game scene information may be constructed based on the second object description data and is transmitted to the developer. The developer may update the game world of the game application based on the associated game scene information as needed, that is, construct an associated game scene corresponding to the associated game scene information. Meanwhile, the computer device may reserve the unassociated object, and may add the unassociated object to the associated game scene as an NPC or the like in the associated game scene when the associated game scene is generated. For example, the second object description data is “She is a heroic knight who likes to travel around Sichuan and help those in need. During an investigation of XX Villa, she discovered that there was an unimaginable plot in XX Villa. For this reason, she hid herself and sneaked into XX Villa to investigate, leaving behind a mysterious legend . . . ”. Associated game scene information “Plot in XX Villa, and an unassociated object assists” is constructed based on the second object description data. When needed, the developer may construct the associated game scene based on the associated game scene information, which refers to an XX Villa instance herein.

In the aspects of this disclosure, the first virtual object may be displayed in response to the object search operation. The first virtual object is generated according to the first object keyword. The first object keyword is acquired from the keyword set based on the object search operation. The object association result for the first virtual object is displayed in response to the object association request for the first virtual object. Through the foregoing process, the first virtual object may be generated. The generation is performed based on the randomly acquired first object keyword, whereby each first virtual object is randomly generated. Before the first virtual object is displayed, the player does not know which virtual object will be displayed, or even does not know where the virtual object will be displayed. In this way, the first virtual object is unknown to the player. In addition, the virtual object does not need to be generated in advance. In this way, various and infinite virtual objects can be generated in a published game application by the method, to improve intelligence and flexibility of a game. Furthermore, extensibility of the game can be improved. In this way, the game application is not limited to existing game resources. Therefore, richness of the game is improved, and playability of the game can be improved to an extent.

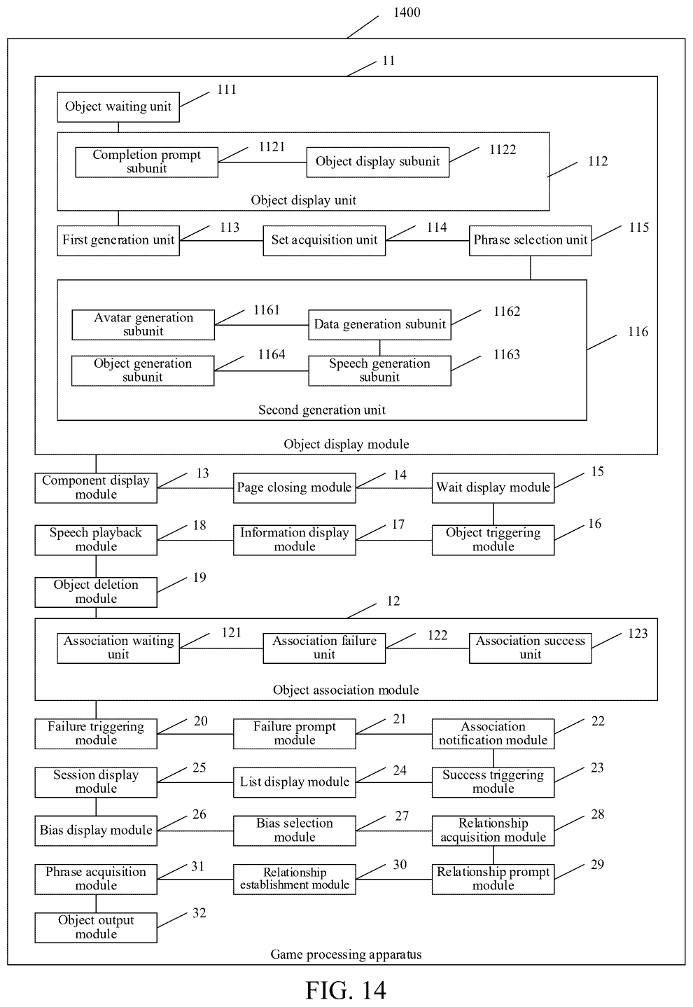

Further, FIG. 14 is a schematic diagram of a game processing apparatus according to an aspect of this disclosure. The game processing apparatus may be a computer program (including program code) run on a computer device. For example, the game processing apparatus is application software. The apparatus may be configured to perform the corresponding operations in the methods provided in the aspects of this disclosure. As shown in FIG. 14, a game processing apparatus 1400 may be applied to the computer device in the aspect corresponding to FIG. 3. Specifically, the apparatus may include: an object display module 11 and an object association module 12.

The object display module 11 is configured to display a first virtual object in response to an object search operation. The first virtual object is an intelligently running game object and is generated according to a first object keyword. The first object keyword is acquired from a keyword set based on the object search operation.

The object association module 12 is configured to display an association success result for the first virtual object in response to an object association request of a second virtual object for the first virtual object when the first virtual object is successfully associated with the second virtual object. The second virtual object is a game object controlled by a game operator.

The object display module 11 includes:
an object waiting unit 111, configured to display an object search waiting page in response to the object search operation; and
an object display unit 112, configured to display the first virtual object when the first virtual object is generated based on the object search operation, the object search waiting page being configured to wait for generation of the first virtual object.

The apparatus 1400 further includes:
a component display module 13, configured to display a first game interface in response to a page closing operation for the object search waiting page, and display a first association component on the first game interface, the first game interface being an interface for interaction in a game application.

The object display unit 112 includes:
a completion prompt subunit 1121, configured to display search completion data for the first association component when the first virtual object is generated based on the object search operation; and
an object display subunit 1122, configured to display the first virtual object in response to a trigger operation for the first association component.

The apparatus 1400 further includes:
a page closing module 14, configured to display the first game interface in response to the page closing operation for the object search waiting page;
a wait display module 15, configured to display the object search waiting page in response to a trigger operation for a second association component displayed on the first game interface if the first virtual object is not generated; and
an object triggering module 16, configured to perform a process of displaying the first virtual object in response to the trigger operation for the second association component displayed on the first game interface if the first virtual object is generated based on the object search operation.

The apparatus 1400 further includes:
an information display module 17, configured to display a first object avatar and first object information for the first virtual object, the first object avatar and the first object information being generated based on the acquired first object keyword; and the first object information being configured to describe the first virtual object and including a first object speech; and
a speech playback module 18, configured to play the first object speech in response to a trigger operation for the first object speech.

The apparatus 1400 further includes:
an object deletion module 19, configured to display a third association component, and delete an unassociated object from the first virtual object in response to a trigger operation for the third association component, the unassociated object being a first virtual object that is not associated with the second virtual object; the second virtual object being a virtual object triggering the object search operation; and the third association component being configured to re-trigger a process of generating the first virtual object; and
the wait display module 15, further configured to display the object search waiting page, the object search waiting page being configured to wait for re-generation of the first virtual object.

A quantity of first virtual objects is N, and N is a positive integer. The object association module 12 includes:
an association waiting unit 121, configured to display an association waiting message in response to an object association request for a target virtual object in the N first virtual objects;
an association failure unit 122, configured to display a failure prompt message for the target virtual object if the second virtual object fails to be associated with the target virtual object, and display a failure confirmation component; and
an association success unit 123, configured to display a success prompt message for the target virtual object if the second virtual object is successfully associated with the target virtual object, and display a success confirmation component.

The apparatus 1400 further includes:
a failure triggering module 20, configured to return to display the N first virtual objects in response to a trigger operation for the failure confirmation component; and
a failure prompt module 21, configured to associatively display an association failure message for the target virtual object, the association failure message being configured to indicate that the object association request is not triggered for the target virtual object.

If the second virtual object is successfully associated with the target virtual object, the apparatus 1400 further includes:
an association notification module 22, configured to output an object association message between the first virtual object and the second virtual object in a system notification area; and
a success triggering module 23, configured to display a second game interface in response to a trigger operation for the success confirmation component if a first associated object in the N first virtual objects is greater than or equal to a unit association threshold, the first associated object being a first virtual object that is in the N first virtual objects and that is associated with the second virtual object,
the success triggering module 23, further configured to return to display the N first virtual objects if the first associated object in the N first virtual objects is less than the unit association threshold.

If the second virtual object is successfully associated with the target virtual object, the apparatus 1400 further includes:
a list display module 24, configured to display a game object list in response to a viewing operation for the game object list of the second virtual object, the game object list including a second associated object of the second virtual object; and the second associated object being a virtual object associated with the second virtual object, being an intelligently running game object, and including the target virtual object; and
a session display module 25, configured to display a session page with the target virtual object in response to a session request for the target virtual object;
a bias display module 26, configured to display an object topic bias option of the target virtual object on the session page with the target virtual object, the object topic bias option including M object topic biases, and M being a positive integer; and
a bias selection module 27, configured to associate a first object topic bias with the target virtual object in response to a selection operation for the first object topic bias of the M object topic biases.

The object display module 11 includes:
a first generation unit 113, configured to randomly determine a first object attribute in response to the object search operation, and generate a first object name based on the first object attribute;
a set acquisition unit 114, configured to acquire a first keyword set associated with the first object attribute from the keyword set, the first keyword set including K keywords, as well as object categories and phrase weights that respectively correspond to the K keywords;
a phrase selection unit 115, configured to randomly select the first object keyword from the K keywords according to the object categories and the phrase weights that respectively correspond to the K keywords;
a second generation unit 116, configured to generate the first virtual object according to the first object keyword; and
the object display unit 112, further configured to display the first virtual object.

The second generation unit 116 includes:
an avatar generation subunit 1161, configured to generate the first object avatar according to the first object keyword;
a data generation subunit 1162, configured to acquire a game world background of the game application, and generate first object description data and object initial data according to the first object keyword and the game world background;
a speech generation subunit 1163, configured to acquire a timbre option corresponding to the first object attribute, randomly select a first object timbre from the timbre option, and generate the first object speech for the object initial data according to the first object timbre; and
an object generation subunit 1164, configured to generate the first virtual object according to the first object avatar, the first object description data, and the first object speech.

The apparatus 1400 further includes:
a relationship acquisition module 28, configured to acquire a game relationship in the game application, and acquire a first game relationship from the game relationship according to the first object attribute and a second object attribute of the second virtual object, the first game relationship being configured to represent an establishable relationship between the first virtual object and the second virtual object; and the second virtual object being a virtual object triggering the object search operation;
a relationship prompt module 29, configured to display a relationship establishment prompt message when the first virtual object and the second virtual object satisfy an establishment condition of a second game relationship, the first game relationship including the second game relationship; and
a relationship establishment module 30, configured to establish the second game relationship between the first virtual object and the second virtual object in response to a relationship establishment operation for the relationship establishment prompt message.

The apparatus 1400 further includes:
a phrase acquisition module 31, configured to acquire an object missing scene in the game application if a virtual object of a first object type is missing from the game application, and acquire an application object keyword based on the first object type and the object missing scene; and
an object output module 32, configured to generate a third virtual object according to the application object keyword, and output the third virtual object in the object missing scene, the third virtual object being an intelligently running game object.

The aspects of this disclosure provide the game processing apparatus. The apparatus may display the first virtual object in response to the object search operation. The first virtual object is an intelligently running game object and is generated based on the first object keyword acquired based on the object search operation. The association success result for the first virtual object is displayed in response to the object association request of the second virtual object for the first virtual object when the first virtual object is successfully associated with the second virtual object. The second virtual object is a game object controlled by the game operator. Through the foregoing process, the first virtual object may be generated. The generation is performed based on the randomly acquired first object keyword, whereby each first virtual object is generated in real time when requested. Before the first virtual object is displayed, a player does not know which virtual object will be displayed, or even does not know where the virtual object will be displayed. In this way, the first virtual object is unknown to the player. In addition, the virtual object does not need to be generated in advance. In this way, various and infinite virtual objects can be generated in a published game application by the method, to improve intelligence and flexibility of a game. Furthermore, extensibility of the game can be improved. In this way, the game application is not limited to existing game resources. Therefore, richness of the game is improved, and playability of the game can be improved to an extent.

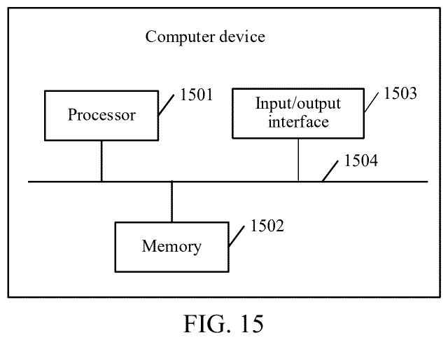

FIG. 15 is a schematic structural diagram of a computer device according to an aspect of this disclosure. As shown in FIG. 15, the computer device provided in the aspects of this disclosure includes: processing circuitry, such as one or more processors 1501, a memory 1502 (e.g., a non-transitory computer-readable storage medium), and an input/output interface 1503. The processor 1501, the memory 1502, and the input/output interface 1503 are connected via a bus 1504. The memory 1502 is configured to store a computer program. The computer program includes program instructions. The input/output interface 1503 is configured to receive and output data, for example, configured to perform data interaction between a service device and a server. The processor 1501 is configured to execute the program instructions stored in the memory 1502.

The processor 1501 may perform the following operations:
displaying a first virtual object in response to an object search operation, the first virtual object being an intelligently running game object and generated according to a first object keyword; and the first object keyword being acquired from a keyword set based on the object search operation; and
displaying an association success result for the first virtual object in response to an object association request of a second virtual object for the first virtual object when the second virtual object is successfully associated with the first virtual object, the second virtual object being a game object controlled by a game operator.

In some possible implementations, the processor 1501 may be a central processing unit (CPU), or the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The memory 1502 may include a read-only memory and a random-access memory, and provides instructions and data to the processor 1501 and the input/output interface 1503. A part of the memory 1502 may further include a non-volatile random-access memory. For example, the processor 1502 further stores information of a device type.

In a specific implementation, the computer device may perform implementations provided by the operations in FIG. 3 by using built-in functional modules of the computer device. For examples of details, reference can be made to the implementations provided by the operations in FIG. 3. Details are not described herein again.

The aspects of this disclosure provide the computer device, which includes: the processor, the input/output interface, and the memory. The processor acquires the computer program in the memory, and performs the operations of the method shown in FIG. 3 to perform game processing operations. In the aspects of this disclosure, the first virtual object may be displayed in response to the object search operation. The first virtual object is generated based on the first object keyword randomly acquired based on the object search operation. The object association result for the first virtual object is displayed in response to the object association request for the first virtual object. Through the foregoing process, the first virtual object may be generated. The generation is performed based on the randomly acquired first object keyword, whereby each first virtual object is randomly generated. Before the first virtual object is displayed, a player does not know which virtual object will be displayed, or even does not know where the virtual object will be displayed. In this way, the first virtual object is unknown to the player. In addition, the virtual object does not need to be generated in advance. In this way, various and infinite virtual objects can be generated in a published game application by the method, to improve intelligence and flexibility of a game. Furthermore, extensibility of the game can be improved. In this way, the game application is not limited to existing game resources. Therefore, richness of the game is improved, and playability of the game can be improved to an extent.

The aspects of this disclosure further provide a computer-readable storage medium such as a non-transitory computer-readable storage medium, which has a computer program stored therein. A processor loads and executes the computer program to perform the game processing method provided by the operations in FIG. 3. For examples of details, reference can be made to the implementations provided by the operations in FIG. 3. Details are not described herein again. In addition, the description of beneficial effects of the same method are not described herein again. For examples of technical details that are not disclosed in the aspects of the computer-readable storage medium involved in this disclosure, reference can be made to the descriptions of the method aspects of this disclosure. In an example, the computer program may be deployed to be executed on one computer device, or executed on a plurality of computer devices located at one location, or executed on a plurality of computer devices distributed at a plurality of locations and connected by a communication network.

The computer-readable storage medium may be an internal storage unit in the game processing apparatus or computer device provided in any one of the foregoing aspects, such as a hard disk or an internal memory in the computer device. Alternatively, the computer-readable storage medium may be an external storage device of the computer device, such as a plug-in hard disk, a smart media card (SMC), a secure digital (SD) card, or a flash card equipped on the computer device. Further, the computer-readable storage medium may further include both the internal storage unit and the external storage device of the computer device. The computer-readable storage medium is configured to store the computer program and other programs and data that are required by the computer device. The computer-readable storage medium may be further configured to temporarily store data that has been outputted or is to be outputted.

The aspects of this disclosure further provide a computer program product or a computer program, which includes computer instructions. The computer instructions are stored in a computer-readable storage medium. A processor of a computer device reads the computer instructions from the computer-readable storage medium and executes the computer instructions, to cause the computer device to perform the method provided in each alternative implementation in FIG. 3. In this way, the first virtual object is generated. The generation is performed based on the randomly acquired first object keyword, whereby each first virtual object is randomly generated. Before the first virtual object is displayed, a player does not know which virtual object will be displayed, or even does not know where the virtual object will be displayed. In this way, the first virtual object is unknown to the player. In addition, the virtual object does not need to be generated in advance. In this way, various and infinite virtual objects can be generated in a published game application by the method, to improve intelligence and flexibility of a game. Furthermore, extensibility of the game can be improved. In this way, the game application is not limited to existing game resources. Therefore, richness of the game is improved, and playability of the game can be improved to an extent.

The terms “first”, “second”, and the like in the description of the aspects of this disclosure, the claims, and the drawings are intended to distinguish between different objects, instead of describing a particular sequence. In addition, the terms “include” and any variation thereof are intended to cover a non-exclusive inclusion. For example, a process, a method, an apparatus, a product, or a device including a series of operations or units is not limited to the listed operations or modules, but instead, include operations or modules not listed in some aspects, or include other operations or units inherent to the process, the method, the apparatus, the product, or the device in some aspects.

Those of ordinary skill in the art may realize that the units and algorithm operations described with reference to the aspects disclosed herein can be implemented in electronic hardware, computer software, or a combination of the electronic hardware and the computer software. To describe the interchangeability of hardware and software, the compositions and operations have been described in terms of function in the description. Whether the functions are executed in the form of hardware or software depends on particular applications and design constraint conditions of the technical solutions. Those skilled in the art may use different methods to implement the described functions for each particular application, but such implementation is not to be considered beyond the scope of this disclosure.

The method and related apparatus provided in the aspects of this disclosure are described with reference to the method flowcharts and/or schematic structural diagrams provided in the aspects of this disclosure. Specifically, each process and/or block in the method flowcharts and/or schematic structural diagrams and a combination of processes and/or blocks in the flowcharts and/or block diagrams may be implemented according to computer program instructions. The computer program instructions may be provided to a general-purpose computer, a dedicated computer, an embedded processing machine, or a processor of another programmable game processing device, to generate a machine, whereby the instructions executed by the computer or the processor of the another programmable data processing device generate an apparatus configured to implement the functions specified in one or more processes of the flowcharts and/or one or more blocks of the schematic structural diagrams. Alternatively, the computer program instructions may be stored in a computer-readable memory that can guide a computer or another programmable data processing device to operate in a specific manner, whereby the instructions stored in the computer-readable memory generate an artifact including an instruction apparatus. The instruction apparatus implements the functions specified in one or more processes of the flowcharts and/or one or more blocks of the schematic structural diagrams. Alternatively, the computer program instructions may be loaded onto a computer or another programmable data processing device, whereby a series of operations are performed on the computer or the another programmable device to generate computer-implemented processing. Therefore, the instructions executed on the computer or the another programmable device provide operations for implementing the functions specified in one or more processes of the flowcharts and one or more blocks of the schematic structural diagrams.

The operations of the method provided in the aspects of this disclosure may be adjusted in terms of sequence, combined, and deleted as needed.

The modules of the apparatus provided in the aspects of this disclosure may be combined, divided, or deleted as needed.

The above are merely some examples of aspects of this disclosure, and are not intended to limit the scope of the claims of this disclosure. Therefore, equivalent variations fall within the scope of this disclosure.

What is claimed is:

1. A game processing method in a game application, comprising:
receiving a virtual object request;
obtaining a first virtual object in response to the virtual object request, the first virtual object being generated based on a first keyword that is selected from a keyword set and is associated with the first virtual object;
displaying the first virtual object; and
displaying, in response to an object association request, an indication that the first virtual object is associated with a second virtual object when the second virtual object controlled by a user is associated with the first virtual object.

2. The game processing method according to claim 1, wherein the first keyword is randomly selected from the keyword set.

3. The method according to claim 1, further comprising:
displaying a viewing component on a first game interface;
displaying attribute information of the first virtual object; and
displaying the first virtual object in response to a trigger operation being performed on the viewing component in the first game interface.

4. The method according to claim 1, further comprising:
displaying a first object avatar and first object information of the first virtual object, the first object avatar and the first object information being generated based on the first keyword, the first object information including a first object speech; and
playing the first object speech in response to a trigger operation being performed on the first object information.

5. The method according to claim 4, wherein a plurality of first virtual objects is obtained and displayed, and the method further comprises:
displaying an association waiting message in response to an object association request for a target virtual object in the plurality of first virtual objects;
when the second virtual object is associated with the target virtual object, displaying a success prompt message for the target virtual object; and
when the second virtual object fails to be associated with the target virtual object, displaying a failure prompt message for the target virtual object.

6. The method according to claim 5, further comprising:
displaying the plurality of first virtual objects in response to a trigger operation being performed on a failure confirmation component that is displayed when the second virtual object fails to be associated with the target virtual object; and
displaying an association failure message for the target virtual object, the association failure message indicating the object association request has failed.

7. The method according to claim 5, wherein when the second virtual object is associated with the target virtual object, the method further comprises:
outputting an object association message between the target virtual object and the second virtual object to a system notification area;
determining a first associated object count, the first associated object count being a number of first virtual objects in the plurality of first virtual objects that are associated with the second virtual object;
when the first associated object count is greater than or equal to a unit association threshold, displaying a second game interface in response to a trigger operation being performed a success confirmation component that is displayed when the second virtual object is associated with the target virtual object; and
when the first associated object count is less than the unit association threshold, displaying the plurality of first virtual objects.

8. The method according to claim 7, wherein when the second virtual object is associated with the target virtual object, the method further comprises:
displaying a game object list in response to a viewing operation for the game object list of the second virtual object, the game object list including a plurality of associated objects that are associated with the second virtual object, the plurality of associated objects including the target virtual object;
displaying a session page with the target virtual object in response to a session request for the target virtual object;
displaying an object topic bias option of the target virtual object on the session page, the object topic bias option including M object topic biases, M being a positive integer, the M object topic biases indicating ideas for an object topic; and
associating a first object topic bias with the target virtual object in response to a selection operation being performed on the first object topic bias of the M object topic biases.

9. The method according to claim 1, wherein the obtaining the first virtual object comprises:
randomly determining a first object attribute;
generating a first object name based on the first object attribute, the first object attribute representing a basic feature of a virtual object;
acquiring the keyword set associated with the first object attribute from a plurality of keyword sets, the keyword set including K keywords, each of the K keywords including an associated respective object category and phrase weight;
selecting the first keyword from keywords in a same object category based on the phrase weights respectively corresponding to the K keywords; and
generating the first virtual object based on the first keyword.

10. The method according to claim 9, wherein the generating the first virtual object comprises:
rendering a first object avatar based on a head-associated phrase in the first keyword;
acquiring a game world background of the game application, and integrating the first keyword and the game world background to generate first object description data and object initial data, the first object description data introducing the first virtual object, and the object initial data representing session data between the first virtual object and the second virtual object;
acquiring a timbre option corresponding to the first object attribute, selecting a first object timbre from the timbre option, and converting the object initial data based on the first object timbre to generate a first object speech; and
forming the first virtual object based on the first object avatar, the first object description data, and the first object speech.

11. The method according to claim 10, further comprising:
acquiring game relationship data in the game application;
based on the game relationship data, acquiring a first game relationship between the first object attribute of the first virtual object and a second object attribute of the second virtual object;
displaying a relationship establishment prompt message when the first virtual object and the second virtual object satisfy an establishment condition of a second game relationship, the first game relationship including the second game relationship; and
establishing the second game relationship between the first virtual object and the second virtual object in response to a relationship establishment operation being performed on the relationship establishment prompt message.

12. The method according to claim 1, further comprising:
detecting that a virtual object of a first object type is to be added to a scene in the game application;
acquiring an application keyword based on the first object type and the scene; and
rendering a third virtual object based on the application keyword and outputting the third virtual object in the scene.

13. A game processing apparatus, comprising:
processing circuitry configured to
receive a virtual object request;
obtain a first virtual object in response to the virtual object request, the first virtual object being generated based on a first keyword that is selected from a keyword set and is associated with the first virtual object;
display the first virtual object; and
display, in response to an object association request, an indication that the first virtual object is associated with a second virtual object when the second virtual object controlled by a user is associated with the first virtual object.

14. The apparatus according to claim 13, wherein the first keyword is randomly selected from the keyword set.

15. The apparatus according to claim 13, wherein the processing circuitry is configured to:
display a viewing component on a first game interface;
display attribute information of the first virtual object; and
display the first virtual object in response to a trigger operation being performed on the viewing component in the first game interface.

16. The apparatus according to claim 13, wherein the processing circuitry is configured to:
display a first object avatar and first object information of the first virtual object, the first object avatar and the first object information being generated based on the first keyword, the first object information including a first object speech; and
play the first object speech in response to a trigger operation being performed on the first object information.

17. The apparatus according to claim 16, wherein a plurality of first virtual objects is obtained and displayed, and the processing circuitry is configured to:
display an association waiting message in response to an object association request for a target virtual object in the plurality of first virtual objects;
when the second virtual object is associated with the target virtual object, display a success prompt message for the target virtual object; and
when the second virtual object fails to be associated with the target virtual object, display a failure prompt message for the target virtual object.

18. The apparatus according to claim 17, wherein the processing circuitry is configured to:
display the plurality of first virtual objects in response to a trigger operation being performed on a failure confirmation component that is displayed when the second virtual object fails to be associated with the target virtual object; and
display an association failure message for the target virtual object, the association failure message indicating the object association request has failed.

19. The apparatus according to claim 17, wherein when the second virtual object is associated with the target virtual object, the processing circuitry is configured to:
output an object association message between the target virtual object and the second virtual object to a system notification area;
determine a first associated object count, the first associated object count being a number of first virtual objects in the plurality of first virtual objects that are associated with the second virtual object;
when the first associated object count is greater than or equal to a unit association threshold, display a second game interface in response to a trigger operation being performed on a success confirmation component that is displayed when the second virtual object is associated with the target virtual object; and
when the first associated object count is less than the unit association threshold, display the plurality of first virtual objects.

20. A non-transitory computer-readable storage medium storing instructions which, when executed by a processor, cause the processor to perform:
receiving a virtual object request;
obtaining a first virtual object in response to the virtual object request, the first virtual object being generated based on a first keyword that is selected from a keyword set and is associated with the first virtual object;
displaying the first virtual object; and
displaying, in response to an object association request, an indication that the first virtual object is associated with a second virtual object when the second virtual object controlled by a user is associated with the first virtual object.
